(19) United States
(12) Patent Application Publication
(10) Pub. No.: US 2017/0098237 A1
(43) Pub. Date: Apr. 6, 2017

(54) NOTIFICATION MACHINE WITH DYNAMIC MESSAGING INTERVAL

(71) Applicant: eBay Inc., San Jose, CA (US)

(72) Inventor: Shu Li, San Jose, CA (US)

(21) Appl. No.: 14/874,676

(22) Filed: Oct. 5, 2015

(51) Int. Cl. G06Q 30/02; G06Q 50/00; H04L 12/58

(52) U.S. Cl. CPC G06Q 30/0244; H04L 51/32; G06Q 30/0264; G06Q 50/01

(57) ABSTRACT

A machine provides a user with repeating messages that reference a purchasable product. The time interval to be inserted between the messages is modified dynamically by the machine, based on a popularity score of the purchasable product, as determined by the machine. The machine accesses social media servers and obtains counts of communications that reference the purchasable product. The machine accesses threshold values that each correspond to a different social media server and its application programming interface (API). By comparing the counts of communications to their corresponding threshold values, the machine determines which counts transgressed their threshold values and calculates a popularity score of the purchasable product based on those counts. Based on the calculated popularity score transgressing a reference popularity score, the machine modifies the time interval that will be inserted between the messages that reference the purchasable product.

### TECHNICAL FIELD

The subject matter disclosed herein generally relates to the technical field of special-purpose machines that facilitate provision of automated notifications to human operators (e.g., users) of such special-purpose machines, including computerized variants of such special-purpose machines and improvements to such variants, and to the technologies by which such special-purpose machines become improved compared to other special-purpose machines that also facilitate automated notifications to human operators. Specifically, the present disclosure addresses systems and methods to facilitate providing notifications with a dynamic messaging interval.

### BACKGROUND

A machine can be configured to interact with one or more users by providing one or more network-based services. For example, a machine may form all or part of a network-based system (e.g., server) that provides a network-based service to its users via devices (e.g., clients) operated by those users. Examples of network-based systems include commerce systems (e.g., shopping websites), publication systems (e.g., classified advertisement websites), listing systems (e.g., wish list websites or gift registries), transaction systems (e.g., payment websites), and social network systems (e.g., Facebook®, Twitter®, or LinkedIn®). To utilize such a service, a user typically accesses the machine via a device and causes or allows the device to provide input data to the machine. In response, the machine determines (e.g., generates, creates, calculates, retrieves, or otherwise obtains) output data and causes the device to present the output data to the user.

### BRIEF DESCRIPTION OF THE DRAWINGS

Some embodiments are illustrated by way of example and not limitation in the figures of the accompanying drawings.

FIG. 1 is a network diagram illustrating a network environment suitable for operating a notification machine, according to some example embodiments.

FIG. 2 is a block diagram illustrating components of a notification machine suitable for dynamically determining a messaging interval and providing automated notifications with the messaging interval, according to some example embodiments.

FIG. 3 is a conceptual diagram illustrating data flows in determining a time interval to be inserted between messages, according to some example embodiments.

FIG. 4 is a block diagram illustrating data structures within a database suitable for dynamically determining a messaging interval, according to some example embodiments.

FIGS. 5-14 are flowcharts illustrating operations of the notification machine in performing a method of determining a messaging interval and providing messages according to the messaging interval, according to some example embodiments.

FIG. 15 is a block diagram illustrating components of a machine, according to some example embodiments, able to read instructions from a machine-readable medium and perform any one or more of the methodologies discussed herein.

### DETAILED DESCRIPTION

Example methods (e.g., algorithms) facilitate determination (e.g., calculation, selection, or modification) of a dynamic messaging interval and provision of automated notifications with the dynamic messaging interval, and example systems (e.g., special-purpose machines) are configured to facilitate determination of a dynamic messaging interval, as well as to provide automated notifications with the dynamic messaging interval. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

A machine (e.g., a notification machine) may be configured to interact with a user by providing one or more automated notifications that are relevant to interactions between the user and the machine. The machine may form all or part of a network-based system (e.g., server system or cloud) that provides network-based services (e.g., shopping services, auction services, social network services, social media services, or any suitable combination thereof) to its users. In addition to providing such network-based services, such a machine can be configured to determine (e.g., generate or update) a dynamic messaging interval and subsequently provide automated messages (e.g., notifications) according to the dynamic message interval (e.g., at a corresponding frequency of communication).

According to the example embodiments discussed herein, the machine is specially configured (e.g., programmed by one or more software modules or other code) to access stored data that specifies a time interval to be inserted between consecutive messages that will be sent to a user. In certain example implementations, these messages will reference a purchasable product. As used herein, a “product” is a good (e.g., a physical object), a service (e.g., performed by a service provider), information (e.g., digital media), a license (e.g., authorization to access something), or any suitable combination thereof. An item may be a specimen (e.g., an individual instance) of the product, and multiple items may constitute multiple specimens of the same product. Accordingly, a user interested in purchasing a specimen of the product may seek information regarding the product, including one or more prices at which the product or specimens thereof are available for purchase. As one example, a user may request or otherwise arrange for the machine to send the user consecutive messages that reference the purchasable product (e.g., with each message including an updated or otherwise contemporary price for the purchasable product).

The time interval to be inserted between the messages may be modified (e.g., adjusted, updated, edited, revised, re-selected, or otherwise changed) dynamically from one value to another by the machine, based on a popularity score of the purchasable product, as determined by the machine. According to example embodiments discussed herein, the machine accesses a set of social media servers (e.g., multiple social media servers) that each provide a different social media service (e.g., Facebook®, Pinterest®, or Instagram®) to their respective users. This accessing includes requesting and obtaining counts of communications that each referenced the purchasable product during a time span (e.g., a query time span), which may be a common time span specified in respective requests to the social media servers. Each of the social media servers may provide its own application programming interface (API), and each of the requests for counts of communications may be sent to a different social media server via its corresponding API (e.g., a proprietary API call). The machine also accesses a set of threshold values (e.g., multiple threshold values) from database. Each one of these threshold values corresponds to a different social media server among the accessed social media servers, such that each one of these threshold values also corresponds to a different API (e.g., a different social media service API among the APIs provided by the social media servers).

By comparing the counts of communications to their corresponding threshold values, the machine determines which counts (e.g., a subset of the counts) transgressed (e.g., exceeded a maximum threshold value, met a value above a maximum threshold value, fell below a minimum threshold value, or met a value below a minimum threshold value) their corresponding threshold values and calculates a popularity score of the purchasable product based on those counts (e.g., the subset of the counts). The machine also performs a comparison of the calculated popularity score with a reference popularity score (e.g., threshold popularity score).

Based on the calculated popularity score transgressing the reference popularity score, the machine modifies the time interval that will be inserted between the messages that reference the purchasable product. The time interval may be reduced to increase the frequency of communication, or the time interval may be enlarged to decrease the frequency of communication. For example, if the elapsed time since the previous message is less than the modified time interval, the next message may be communicated when the elapsed time meets or exceeds the modified time interval, and subsequent messages may be communicated according to (e.g., temporally spaced apart by) the modified time interval (e.g., at least until the machine dynamically updates the time interval again). As another example, if the elapsed time since the previous message is greater than the modified time interval, the next message may be communicated immediately, and subsequent messages may be communicated according to the modified time interval (e.g., at least until the machine dynamically updates the time interval again).

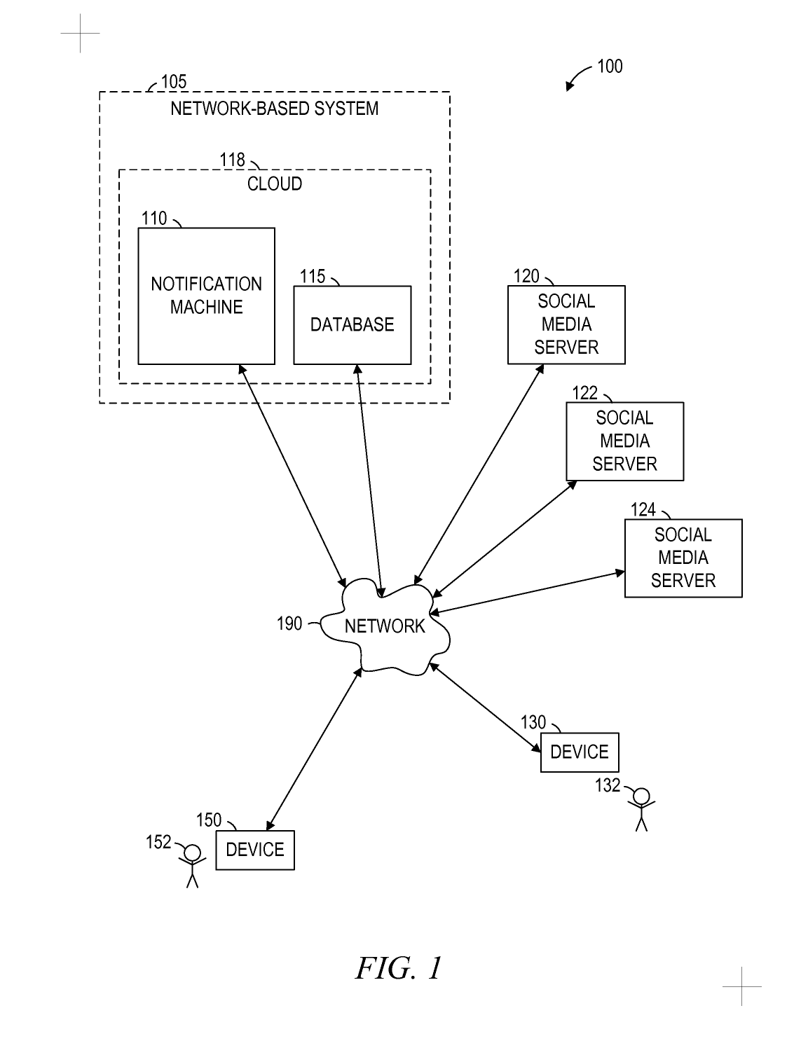

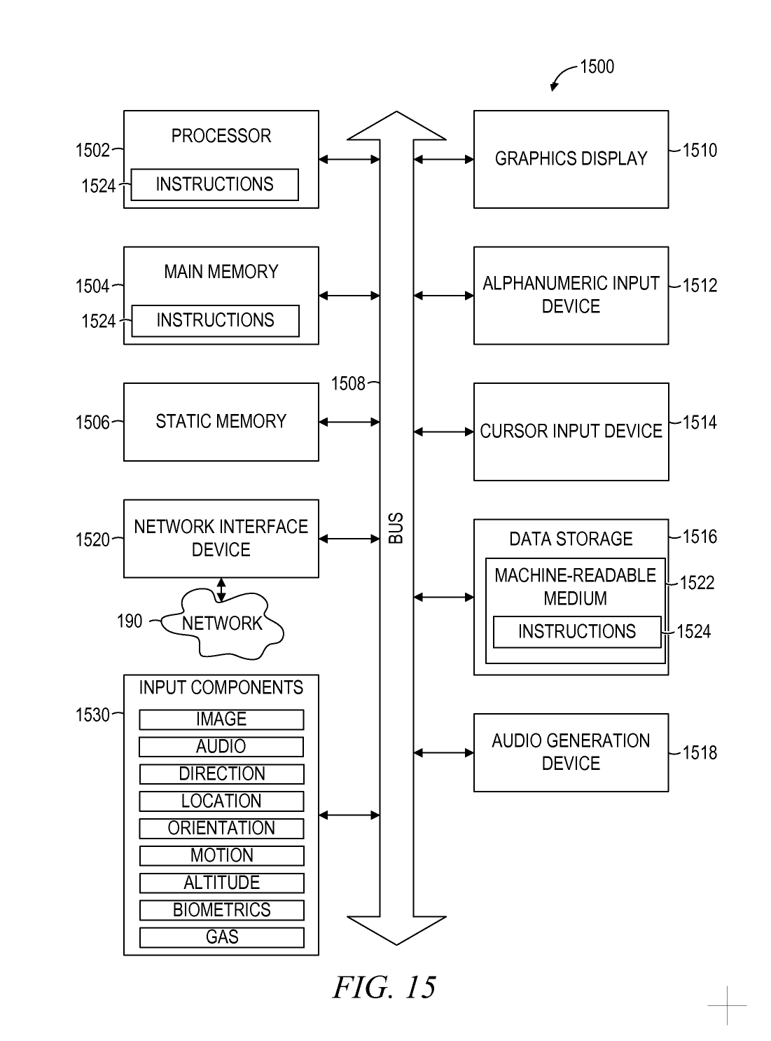

FIG. 1 is a network diagram illustrating a network environment 100 suitable for operating a notification machine 110, according to some example embodiments. The network environment 100 includes the notification machine 110, a database 115, social media servers 120, 122, and 124, and devices 130 and 150, all communicatively coupled to each other via a network 190. The notification machine 110, with or without the database 115, may form all or part of a cloud 118 (e.g., a geographically distributed set of multiple machines configured to function as a single server), which may form all or part of a network-based system 105 (e.g., a cloud-based server system configured to provide one or more network-based services to the devices 130 and 150). The notification machine 110 and the devices 130 and 150 may each be implemented in a special-purpose (e.g., specialized) computer system, in whole or in part, as described below with respect to FIG. 15.

The social media servers 120, 122, and 124 each provide different social media services (e.g., social networking services that include sharing communications regarding media among users) to its respective users. Each of the social media servers 120, 122, and 124 provides a corresponding (e.g., proprietary) API for accessing information stored thereon. For example, the social media server 120 (e.g., a Facebook® server) may be a first social media server that provides a first social media service to a first group of users, as well as support a corresponding first API for accessing data regarding the first group of users (e.g., a first count of communications that reference a particular purchasable product within a query time span). As another example, the social media server 122 (e.g., a Pinterest® server) may be a second social media server that provides a second social media service to a second group of users (e.g., partially overlapping the first group of users), as well as support a corresponding second API for accessing data regarding the second group of users (e.g., a second count of communications that reference the particular purchasable product within the query time span). As yet another example, the social media server 124 (e.g., an Instagram® server) may constitute a third social media server that provides a third social media service to a third group of users (e.g., partially overlapping the first and second groups of users), as well as support a corresponding third API for accessing data regarding the third group of users (e.g., a third count of communications that reference the particular purchasable product within the query time span).

Also shown in FIG. 1 are users 132 and 152. One or both of the users 132 and 152 may be a human user (e.g., a human being), a machine user (e.g., a computer configured by a software program to interact with the device 130 or 150), or any suitable combination thereof (e.g., a human assisted by a machine or a machine supervised by a human). The user 132 is associated with the device 130 and may be a user of the device 130. For example, the device 130 may be a desktop computer, a vehicle computer, a tablet computer, a navigational device, a portable media device, a smart phone, or a wearable device (e.g., a smart watch, smart glasses, smart clothing, or smart jewelry) belonging to the user 132. Likewise, the user 152 is associated with the device 150 and may be a user of the device 150. As an example, the device 150 may be a desktop computer, a vehicle computer, a tablet computer, a navigational device, a portable media device, a smart phone, or a wearable device (e.g., a smart watch, smart glasses, smart clothing, or smart jewelry) belonging to the user 152.

Any of the systems or machines (e.g., servers, databases, and devices) shown in FIG. 1 may be, include, or otherwise be implemented in a special-purpose (e.g., specialized or otherwise non-generic) computer that has been modified (e.g., configured or programmed by software, such as one or more software modules of an application, operating system, firmware, middleware, or other program) to perform one or more of the functions described herein for that system or machine. For example, a special-purpose computer system able to implement any one or more of the methodologies described herein is discussed below with respect to FIG. 15, and such a special-purpose computer may accordingly be a means for performing any one or more of the methodologies discussed herein. Within the technical field of such special-purpose computers, a special-purpose computer that has been modified by the structures discussed herein to perform the functions discussed herein is technically improved compared to other special-purpose computers that lack the structures discussed herein or are otherwise unable to perform the functions discussed herein. Accordingly, a special-purpose machine configured according to the systems and methods discussed herein provides an improvement to the technology of similar special-purpose machines.

As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the systems or machines illustrated in FIG. 1 may be combined into a single machine, and the functions described herein for any single system or machine may be subdivided among multiple systems or machines.

The network 190 may be any network that enables communication between or among systems, machines, databases, and devices (e.g., between the notification machine 110 and the device 130). Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof. Accordingly, the network 190 may include one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., a WiFi network or WiMax network), or any suitable combination thereof. Any one or more portions of the network 190 may communicate information via a transmission medium. As used herein, “transmission medium” refers to any intangible (e.g., transitory) medium that is capable of communicating (e.g., transmitting) instructions for execution by a machine (e.g., by one or more processors of such a machine), and includes digital or analog communication signals or other intangible media to facilitate communication of such software.

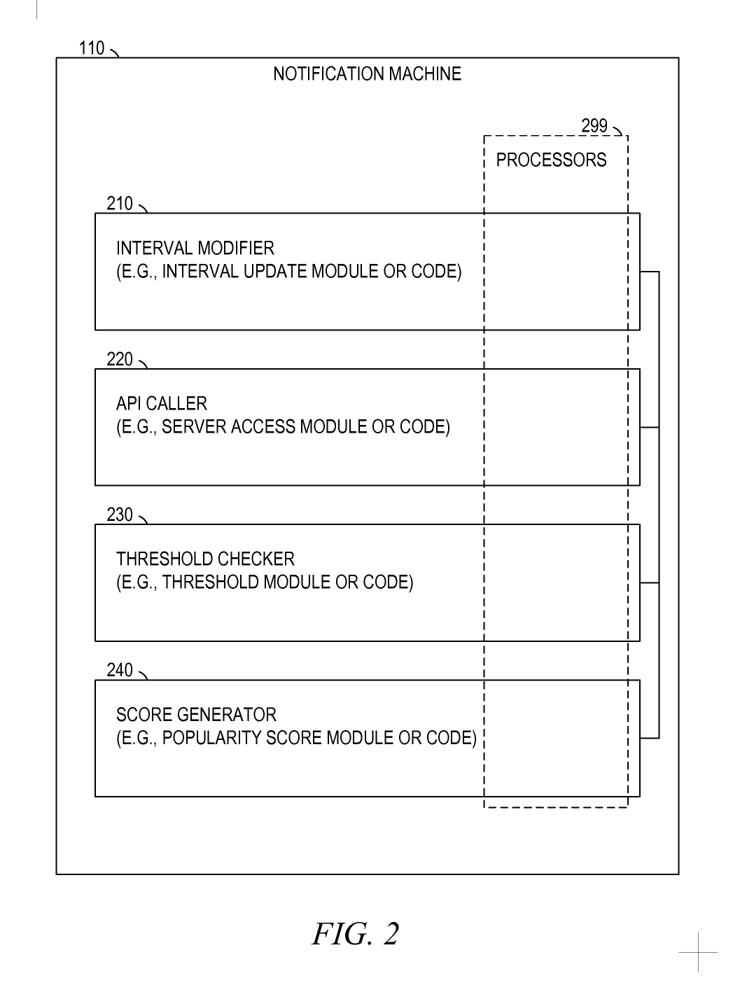

FIG. 2 is a block diagram illustrating components of the notification machine 110, according to some example embodiments. The notification machine 110 is shown as including an interval modifier 210, an API caller 220, a threshold checker 230, and a score generator 240, all configured to communicate with each other (e.g., via a bus, shared memory, or a switch). The interval modifier 210 may be or include an interval update module (e.g., software module) or other code that configures one or more processors 299 to perform functions described herein for the interval modifier 210. The API caller 220 may be or include a server access module or other code that configures one or more of the processors 299 to perform functions described herein for the API caller 220. The threshold checker 230 may be or include a threshold module or other code that configures one or more of the processors 299 to perform functions described herein for the threshold checker 230. The score generator 240 may be or include a popularity score module or other code that configures one or more of the processors 299 to perform functions described herein for the score generator 240.

The interval modifier 210, the API caller 220, the threshold checker 230, and the score generator 240 together may form all or part of an application (e.g., a software application, applet, or mobile app) that is stored (e.g., installed) on the notification machine 110 and executable by one or more of the processors 299 thereon. Furthermore, one or more of the processors 299 (e.g., hardware processors, digital processors, or any suitable combination thereof) may be included (e.g., temporarily or permanently) in the interval modifier 210, the API caller 220, the threshold checker 230, the score generator 240, or any suitable combination thereof.

Any one or more of the components (e.g., modules) described herein may be implemented using hardware alone (e.g., one or more of the processors 299) or a combination of hardware and software. For example, any component described herein may physically include an arrangement of one or more of the processors 299 (e.g., a subset of or among the processors 299) configured to perform the operations described herein for that component. As another example, any component described herein may include software, hardware, or both, that configure an arrangement of one or more of the processors 299 to perform the operations described herein for that component. Accordingly, different components described herein may include and configure different arrangements of the processors 299 at different points in time or a single arrangement of the processors 299 at different points in time. Each component (e.g., module) described herein is an example of a means for performing the operations described herein for that component. Moreover, any two or more components described herein may be combined into a single component, and the functions described herein for a single component may be subdivided among multiple components. Furthermore, according to various example embodiments, components described herein as being implemented within a single system or machine (e.g., a single device) may be distributed across multiple systems or machines (e.g., multiple devices).

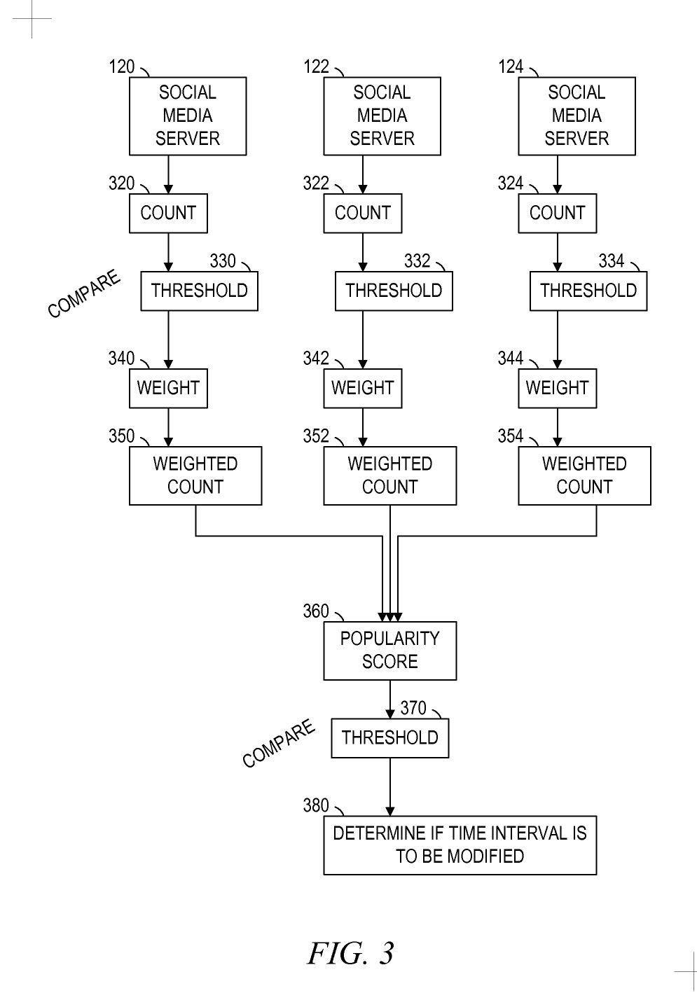

FIG. 3 is a conceptual diagram illustrating data flows in determining a time interval to be inserted between messages (e.g., consecutive messages to the user 132, all in reference to the same purchasable product), according to some example embodiments. As shown in FIG. 3, each of the social media servers 120, 122, and 124 provides (e.g., to the notification machine 110) corresponding counts 320, 322, and 324 of communications. According to various example embodiments, the counts 320, 322, and 324 of communications are numerical values that quantify (e.g., count) communications processed (e.g., shared, posted, or otherwise sent from one user of the corresponding social media service to one or more other users of the social media service) within a query time span (e.g., the past hour, the past 24 hours, the past three days, or the past week). Accordingly, these counts 320, 322, and 324 are numerical quantities of such communications.

Furthermore, each one of such counted communications may express a positive sentiment or a negative sentiment (e.g., all regarding the same purchasable product). For example, the API calls supported by the social media server 120 may differentiate between requesting a count of positive communications (e.g., communications that express a positive sentiment) and requesting a count of negative communications (e.g., communications that express a negative sentiment). An API call that requests a count of positive communications (e.g., getCountOfLikes(productID) or readUpvotes(productName)) may cause the social media server 120 return the count 320 as a result of counting communications that both reference the purchasable product and contain at least one positive word from a list of positive words (e.g., “great,” “awesome,” and “nice”). Similarly, an API call that requests a count of negative communications (e.g., getCountOfDislikes(productID) or readDownvotes(productName)) may cause the social media server 120 to return the count 320 as a result of counting communications that both reference the purchasable product and contain at least one negative word from the list of negative words (e.g., “yuck,” “awful,” and “meh”).

As noted above, each of the counted communications may reference the same purchasable product (e.g., a digital camera, a patio furniture set, or a barbecue grill). As examples, the count 320 may be a first count (e.g., 327 or 524) of “likes” indicated in reference to the purchasable product (e.g., a review or comment regarding the purchasable product) by users of a first social media service (e.g., Facebook®); the count 322 may be a second count (e.g., 496 or 731) of “shares” indicated in reference to the purchasable product (e.g., a description of the purchasable product) by users of a second social media service (e.g., Pinterest®); and the count 324 may be a third count (e.g., 244 or 1086) of “upvotes” indicated in reference to the purchasable product (e.g., a photo of the purchasable product) by users of a third social media service (e.g., Instagram®).

As shown in FIG. 3, each of the counts 320, 322, and 324 are then compared (e.g., by the notification machine 110) to respective threshold values 330, 332, and 334. Each of the threshold values 330, 332, and 334 may correspond to a different one among the social media servers 120, 122, and 124 and its corresponding API. As examples, the threshold value 330 corresponds to the social media server 120 and its API and accordingly is compared to its corresponding count 320 obtained from the social media server 120 via its API; the threshold value 332 corresponds to the social media server 122 and its API and accordingly is compared to its corresponding count 322 obtained from the social media server 120 via its API; and the threshold value 334 corresponds to the social media server 124 and its API and accordingly is compared to its corresponding count 324 obtained from the social media server 124 via its API. These threshold values 330, 332, and 334 may be stored in a database (e.g., the database 115) and accessed (e.g., by the notification machine 110) therefrom.

According to certain example embodiments, weight values 340, 342, and 344 are assigned to the social media servers 120, 122, and 124. The notification machine 110 may access these weight values 340, 342, and 344 (e.g., from the database 115) for use in determining a popularity score 360 of the purchasable product referenced by the communications counted by the counts 320, 322, and 324. Depending on implementation, the weight values 340, 342, and 344 may represent different levels of influence for the different social media servers 120, 122, 124. For example, the social media server 120 (e.g., Facebook®) might be assigned a relatively high value (e.g., 0.95) for its corresponding weight value 340 (e.g., on grounds that communications among its users are relatively accurate indicators of popularity for purchasable products), while the social media server 122 (e.g., Pinterest®) might be assigned a relatively low value (e.g., 0.15) for its corresponding weight value 342 (e.g., on grounds that communications among its users are relatively inaccurate indicators of popularity for purchasable products). Similarly, the social media server 124 (e.g., Instagram®) might be assigned a moderate value (e.g., 0.52) for its corresponding weight value 344 (e.g., on grounds that communications among its users are moderately accurate indicators of popularity for purchasable products).

In some example embodiments, only those counts (e.g., counts 320, 322, and 324) that transgress their respective threshold values (e.g., threshold values 330, 332, and 334) are mathematically weighted. FIG. 3 depicts the weight values 340, 342, and 344 being applied respectively to the counts 320, 322, and 324 to obtain respectively corresponding weighted counts 350, 352, and 354. Subsequently, the weighted counts 350, 352, and 354 can be combined (e.g., summed or averaged) to calculate the popularity score 360 of the purchasable product.

As shown in FIG. 3, the calculated popularity score 360 may then be compared (e.g., by the notification machine 110) to a reference value for the popularity score 360. FIG. 3 depicts the popularity score 360 being compared to a threshold value 370 as the reference value. According to various example embodiments, this comparison becomes a basis for a determination 380 of whether the time interval is to be modified. That is, the notification machine 110 may perform this comparison and, if the popularity score 360 transgresses (e.g., exceeds or meets) its threshold value 370, the notification machine 110 performs a dynamic modification of the time interval to be inserted between messages (e.g., price update alerts) that will be sent to the user 132 regarding the purchasable product.

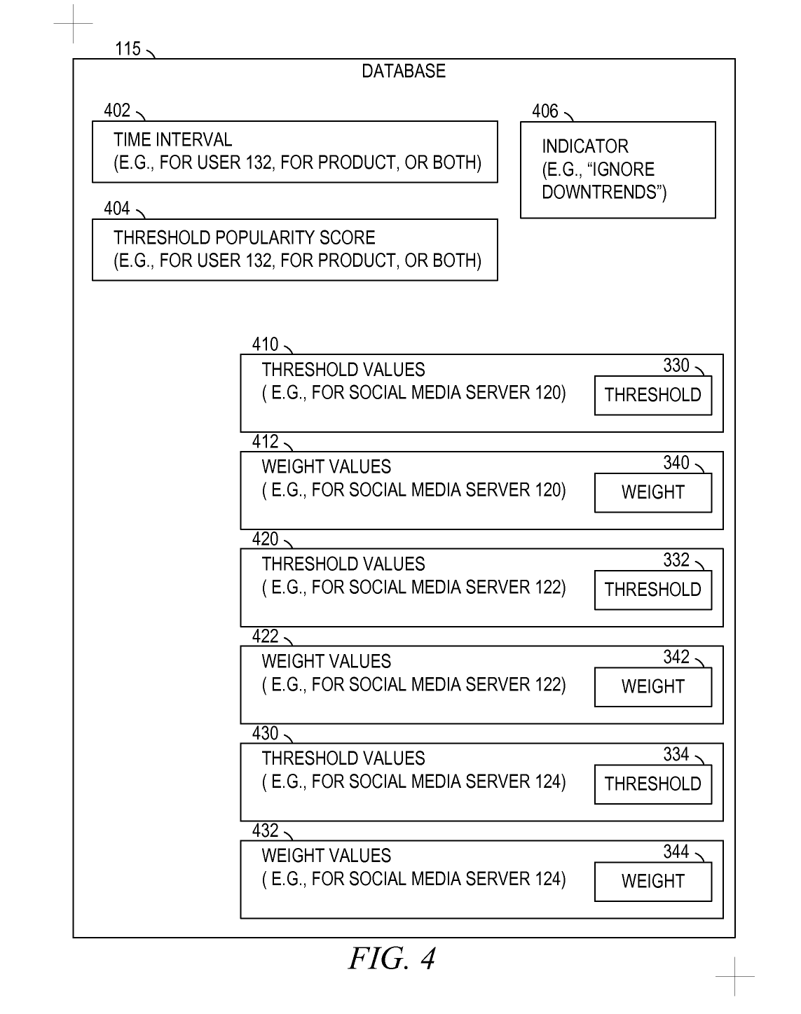

FIG. 4 is a block diagram illustrating data structures within the database 115, according to some example embodiments. The database 115 is shown as storing a time interval 402, a threshold popularity score 404, and an indicator 406 of whether to ignore downward trends in popularity. In addition, the database 115 stores a set of threshold values 410 and a set of weight values 412 that all correspond to the social media server 120 (e.g., Facebook®); a set of threshold values 420 and a set of weight values 422 that all correspond to the social media server 122 (e.g., Pinterest®); and a set of threshold values 430 and a set of weight values 432 that all correspond to the social media server 124 (e.g., Instagram®).

The time interval 402 is to be inserted between consecutive messages to be sent to the user 132. The time interval 402 may be specific to the user 132 (e.g., initially requested by the user 132, assigned to the user 132, or stored in a user profile of the user 132), specific to the purchasable product (e.g., assigned to the purchasable product or stored in a product profile of the purchasable product), or both.

The threshold popularity score 404 may be an example of the threshold value 370 discussed above with respect to FIG. 3. According to certain example embodiments, the threshold popularly score 404 is specific to the user 132, specific to the purchasable product, or both.

The indicator 406, if present, may take the example form of a flag, data field, or other indicator that requests, commands, or otherwise signifies that decreased counts of communications (e.g., indicating downward trends in popularity, which may be called “downtrends”) are to be ignored in calculating popularity scores (e.g., popularity score 360). According to some example embodiments, the indicator 406 is specific to the user 132, specific to the purchasable product, or both.

The set of threshold values 410 (e.g., first set of threshold values) is shown as including the threshold value 330, which is described above as corresponding to the social media server 120 and its API. The set of weight values 412 (e.g., first set of weight values) is shown as including the weight value 340, which is described above as also corresponding to the social media server 120 and its API. Similarly, the set of threshold values 420 (e.g., second set of threshold values) is shown as including the threshold value 332, which is described above as corresponding to the social media server 122 and its API, and the set of weight values 422 (e.g., second set of weight values) is shown as including the weight value 342, which is described above as also corresponding to the social media server 122 and its API. Likewise, the set of threshold values 430 (e.g., third set of threshold values) is shown as including the threshold value 334, which is described above as corresponding to the social media server 124 and its API, and the set of weight values 432 (e.g., third set of weight values) is shown as including the weight value 344, which is described above as also corresponding to the social media server 124 and its API.

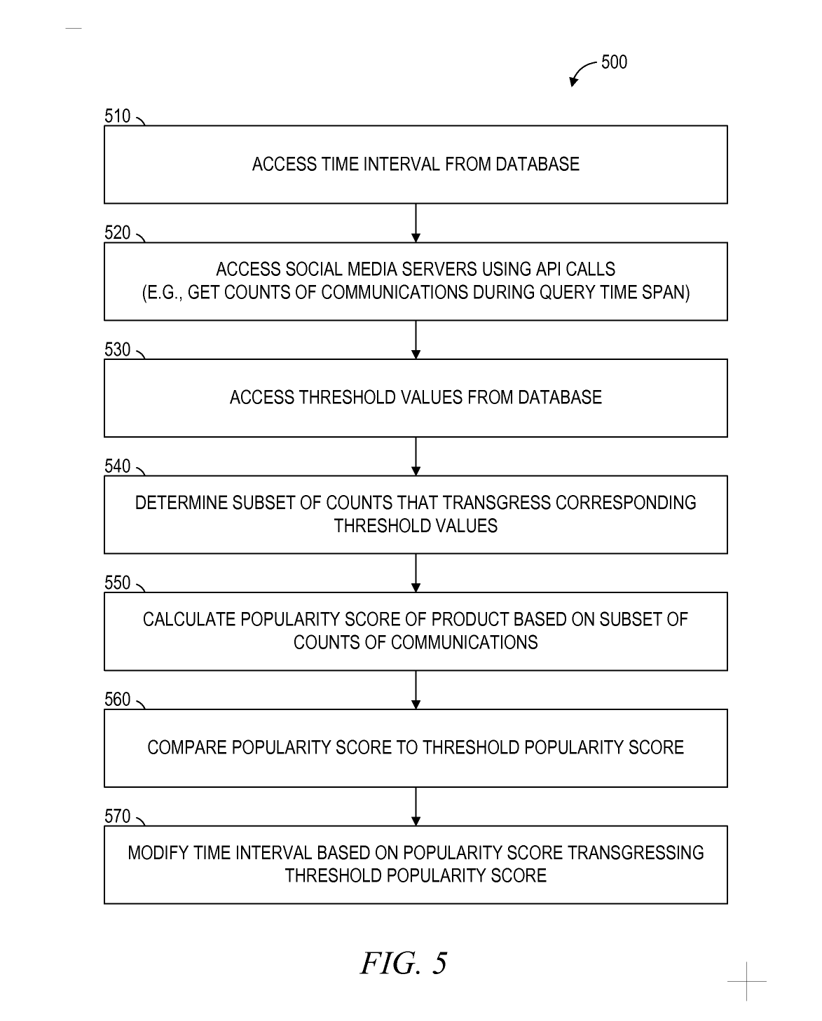

FIGS. 5-14 are flowcharts illustrating operations of the notification machine 110 in performing a method 500 of determining a time interval for insertion between messages (e.g., consecutive, sequential, periodic, or otherwise repeating messages to the user 132, each in reference to the same purchasable product) and providing the messages according to the determined time interval, according to some example embodiments. Operations in the method 500 may be performed using components (e.g., modules) introduced above with respect to FIG. 2, using one or more of the processors 299 (e.g., microprocessors or other hardware processors), or using any suitable combination thereof. As shown in FIG. 5, the method 500 includes operations 510, 520, 530, 540, 550, 560, and 570.

In operation 510, the interval modifier 210 accesses the time interval 402 from the database 115. For example, this may be performed by directly reading the time interval 402 or by requesting and receiving the time interval 402 from the database 115. In other words, the interval modifier 210 may access stored data that specifies the time interval 402, which is to be inserted between messages (e.g., consecutive messages) to be sent to the user 132. As noted above, the messages may each reference the same purchasable product (e.g., by including an identifier of the purchasable product).

In operation 520, the API caller 220 accesses the different social media servers 120, 122, and 124 to obtain the counts 320, 322, and 324 of communications discussed above with respect to FIG. 3. Accordingly, each of the counts 320, 322, and 324 is obtained from a different social media server (e.g., social media server 120, 122, or 124). Further details of operation 520 are discussed below.

In operation 530, the threshold checker 230 accesses the threshold values 330, 332, and 334 from the database 115. For example, this may be performed by directly reading the threshold values 330, 332, and 334 or by requesting and receiving the threshold values 330, 332, and 334 from the database 115. In some example embodiments, the threshold checker 230 accesses the stored sets of threshold values 410, 420, and 430 to obtain the threshold values 330, 332, and 334. As noted above, each of the threshold values 330, 332, and 334 corresponds to a different social media server (e.g., social media server 120, 122, or 124) and its corresponding API (e.g., including its corresponding API calls).

In operation 540, the threshold checker 230 determines a subset of the counts 320, 322, and 324 that were obtained in operation 520. For example, the subset may be determined based on comparisons between the counts 320, 322, and 324 and their respectively corresponding threshold values 330, 332, and 334. Further details of operation 540 are discussed below.

In some situations, the subset is less than the entirety of the counts 320, 322, and 324 obtained in operation 520, while in other situations, the subset includes all of the counts 320, 322, and 324 obtained in operation 520. According to some example embodiments, only those counts (e.g., count 320 and count 322) that transgress their corresponding threshold value (e.g., threshold value 330 and threshold value 332) for their corresponding social media server (e.g., social media server 120 and social media server 122) are included in the subset determined by the threshold checker 230. That is, each count (e.g., count 320) in the subset may transgress its corresponding threshold value (e.g., threshold value 330).

In operation 550, the score generator 240 uses the subset determined in operation 540 to calculate the popularity score 360 of the purchasable product. In some example embodiments, the popularity score 360 is calculated directly from the counts (e.g., counts 320 and 322) included in the subset. In certain example embodiments, the popularity score 360 is calculated after the counts (e.g., counts 320 and 322) have been weighted (e.g., by weight values 340 and 342, to obtain weighted counts 350 and 352).

In operation 560, the threshold checker 230 compares the calculated popularity score 360 to the threshold popularity score 404. For example, the comparing of the calculated popularity score 360 to the threshold popularity score 404 may be performed by comparing their numerical values. Further details of operation 560 are discussed below.

In operation 570, the interval modifier 210 modifies the time interval 402 based on the results of operation 560, in particular, on the comparing of the calculated popularity score 360 to the threshold popularity score 404. In some example embodiments, the interval modifier 210 modifies (e.g., adjust, update, edit, revise, re-select, or otherwise change) the time interval 402 based on (e.g., in response to) the calculated popularity score 360 transgressing the threshold popularity score 404. In certain situations, the calculated popularity score 360 does not transgress the threshold popularity score 404, and performance of operation 570 is canceled by the interval modifier 210 or otherwise does not occur. In other situations, the interval modifier 210 determines (e.g., during operation 570) that the calculated popularity score 360 transgresses the threshold popularity score 404, and the time interval 402 is accordingly modified by the interval modifier 210.

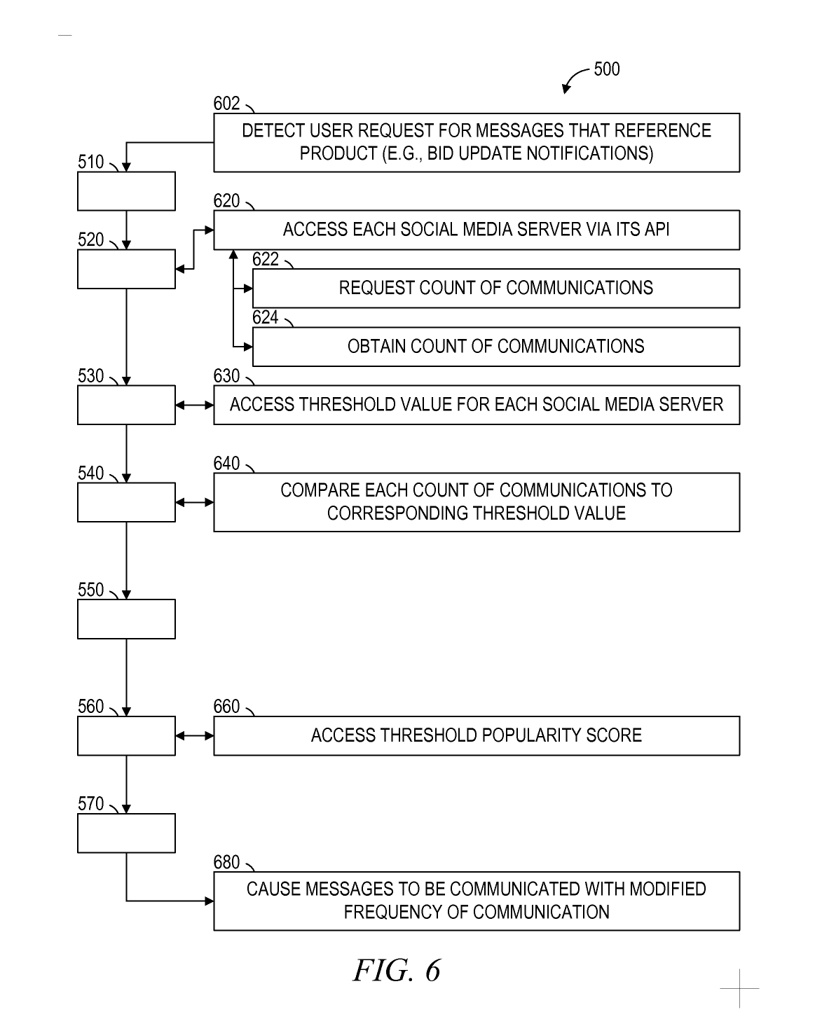

As shown in FIG. 6, the method 500 may include one or more of operations 602, 620, 622, 624, 630, 640, 660, and 680. Operation 602 may be performed prior to operation 510. In operation 602, the interval modifier 210 detects a user request for messages that reference the purchasable product. As noted above, such messages may be consecutive, sequential, periodic, or otherwise repeating messages to the user 132, each in reference to the same purchasable product. As one example, the messages may be or include price update alerts regarding current prices for the purchasable product (e.g., notifications of the current highest bid for a purchasable product being auctioned). In example embodiments that include operation 602, performance of any one or more other operations of the method 500 (e.g., operations 510, 520, 530, 540, 550, 560, and 570) may be in response to the user request detected in operation 602.

Operation 620 may be performed as part (e.g., a precursor task, a subroutine, or a portion) of operation 520, in which the API caller 220 accesses the social media servers 120, 122, and 124. In operation 620, the API caller 220 invokes the corresponding API for each social media server (e.g., social media server 120, 122, or 124) to perform the accessing of that social media server. Accordingly, each of the counts 320, 322, and 324 obtained in operation 520 is obtained from a different social media server (e.g., social media server 120, 122, or 124) via their respectively corresponding APIs (e.g., respectively corresponding API calls). In some example embodiments, a separate accessing operation may be performed for each individual social media server (e.g., social media server 120, 122, or 124).

One or more of operations 622 and 624 may be performed as part of operation 620. The accessing of each one of the social media servers 120, 122, and 124 may include requesting and obtaining its corresponding count (e.g., count 320, 322, or 324) of communications that each referenced the purchasable product during the same query time span (e.g., the past hour, the past 24 hours, the past three days, or the past week). As shown in FIG. 6, the requesting of each count (e.g., count 320, 322, or 324) is performed in operation 622 by the API caller 220, and the obtaining (e.g., accessing, reading, receiving, or retrieval) of each count (e.g., count 320, 322, or 324) is performed in operation 624 by the API caller 220.

Operation 630 may be performed as part of operation 530, in which the threshold checker 230 accesses the threshold values 330, 332, and 334. In operation 630, the threshold checker 230 accesses each of the threshold values 330, 332, and 334 from the database 115 (e.g., by directly reading each of the threshold values 330, 332, and 334 or by requesting and receiving each of the threshold values 330, 332, and 334 from the database 115). In some example embodiments, a separate accessing operation may be performed for each individual threshold value (e.g., threshold value 330, 332, or 334).

Operation 640 may be performed as part of operation 540, in which the threshold checker 230 determines the subset of the counts 320, 322, and 324 obtained in operation 520. As noted above, the determining of the subset may be based on comparisons between the counts 320, 322, and 324 and their respectively corresponding threshold values 330, 332, and 334 (e.g., accessed in operation 530, operation 630, or both). These comparisons may be performed by comparing numerical values of the counts 320, 322, and 324 to their respective threshold values 330, 332, and 334. For example, the threshold checker 230 may compare the count 320 with its corresponding threshold value 330 and determine whether the count 320 is included in the subset, and similar comparisons and determinations can be performed for the count 322 and its threshold value 332, as well as for the count 324 and its threshold value 334. In some example embodiments, inclusion of a count (e.g., count 320) in the subset occurs if the count transgresses its corresponding threshold value (e.g., threshold value 330). That is, a count (e.g., count 324) is excluded from the subset, if the count fails to transgress its corresponding threshold value (e.g., threshold value 334).

Operation 660 may be performed as part of operation 560, in which the threshold checker 230 compares the calculated popularity score 360 to the threshold popularity score 404. In operation 660, the threshold checker 230 accesses the threshold popularity score 404 from the database 115. The accessing of the threshold popularity score 404 may be performed by directly reading the threshold popularity score 404 in the database 115 or by requesting and receiving the threshold popularity score 404 from the database 115.

Operation 680 may be performed after operation 570, in which the interval modifier 210 modifies the time interval 402 (e.g., from a first value to a second value). In operation 680, the interval modifier 210 uses the modified time interval 402 to cause future messages (e.g., repeating messages, each referencing the same purchasable product) to be sent to the user 132 according to the modified time interval 402 (e.g., spaced in time by the modified time interval 402). Thus, the modifying of the time interval 402 in operation 570 causes messages (e.g., periodic messages) that reference the purchasable product to be communicated to the device 130 of the user 132 with a correspondingly modified frequency of communication. According to various example embodiments, the messages each reference the same purchasable product by each including an identifier of the purchasable product. For example, the purchasable product may be listed in a watchlist of the user 132 by virtue of an identifier (e.g., name or code) of the purchasable product appearing in the watchlist, and the messages may each reference the purchasable product by including the identifier of the purchasable product.

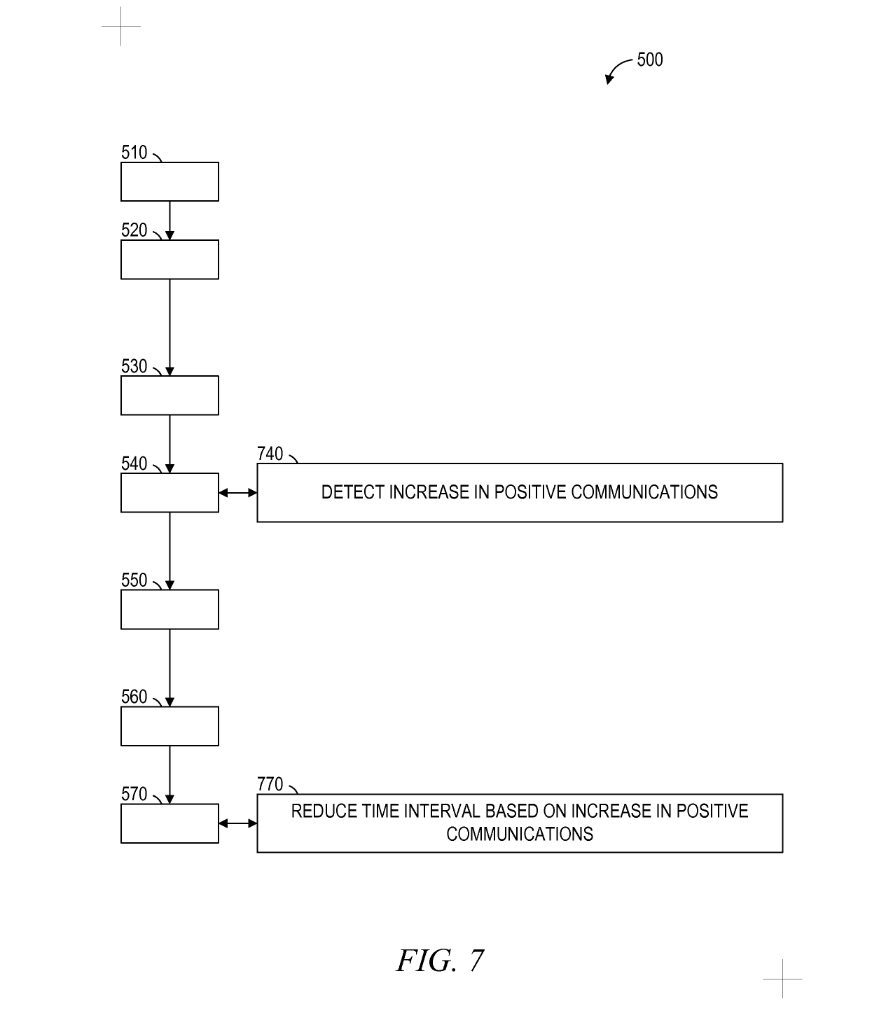

As shown in FIG. 7, the method 500 may include one or more of operations 740 and 770. Operation 740 may be performed as part of operation 540, in which the threshold checker 230 determines the subset of the counts 320, 322, and 324 obtained from operation 520. In example embodiments that include operation 740, the counts 320, 322, and 324 are counts (e.g., numerical quantities) of positive communications that express positive sentiments about the purchasable product (e.g., “likes,” “upvotes,” or other favorable ratings). In operation 740, as part of determining the subset, the threshold checker 230 detects counts (e.g., count 320) that indicate increases in such positive communications compared to previous instances (e.g., from the beginning of, or within, the query time span) of the same counts (e.g., count 320). Such previous instances may be stored in the database 115, accessed by the threshold checker 230, and compared by the threshold checker 230 against their corresponding current instances obtained in operation 520 to detect which of the counts 320, 322, and 324 of positive communications have increased. In example embodiments that include operation 740, the modifying of the time interval 402 in operation 570 has the effect of reducing the time interval 402 in response to an increase in at least one of the counts 320, 322, and 324 of positive communications.

Such a reduction in the time interval 402 may accordingly cause periodic messages that reference the purchasable product to be communicated to the device 130 of the user 132 with an increased frequency of communication. For example, this increase in the frequency of communication may be useful when there is an increasing trend in positive communications being processed by one or more of the social media servers 120, 122, and 124, since a rising trend in positive communications may signify increased public attention on the purchasable product, increasing prices for the purchasable product, decreasing availability of the purchasable product, or any suitable combination thereof. This increase in the frequency of communication is represented in FIG. 7 by operation 770, which may be performed as part of operation 570, in which the interval modifier 210 modifies the time interval 402.

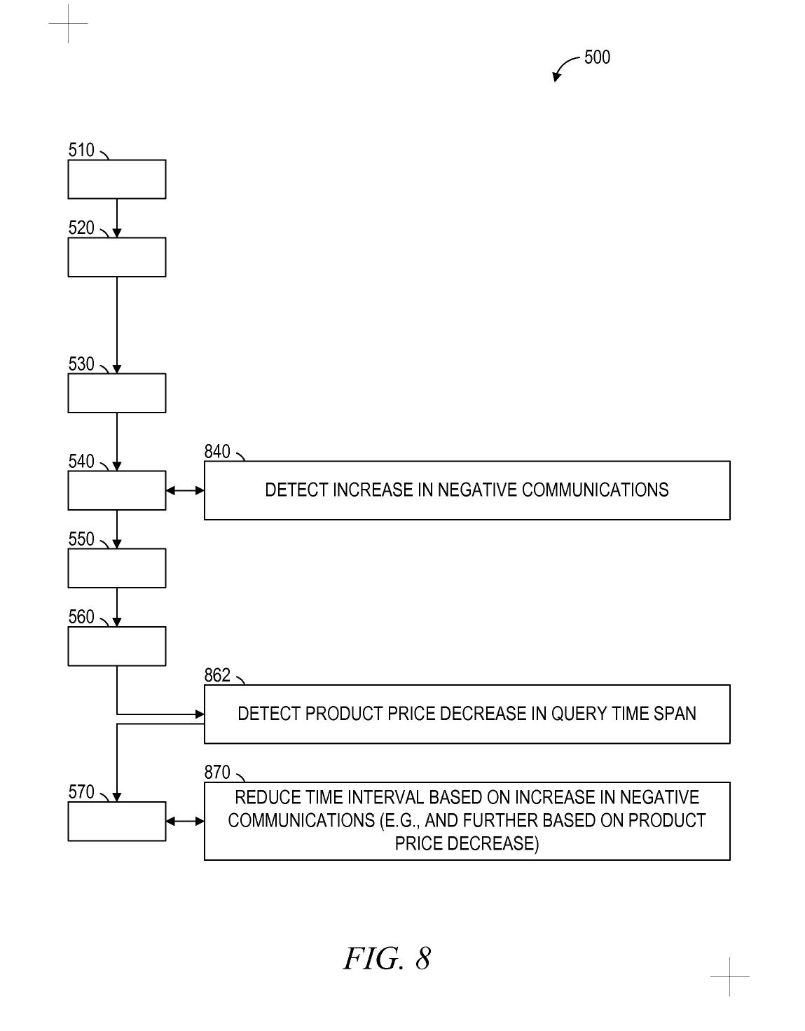

As shown in FIG. 8, the method 500 may include one or more of operations 840, 862, and 870. Operation 840 may be performed as part of operation 540, in which the threshold checker 230 determines the subset of the counts 320, 322, and 324 obtained in operation 520. In example embodiments that include operation 840, the counts 320, 322, and 324 are counts (e.g., numerical quantities) of negative communications that express negative sentiments about the purchasable product (e.g., “dislikes,” “downvotes,” or other unfavorable ratings). In operation 840, as part of determining the subset, the threshold checker 230 detects counts (e.g., count 324) that indicate increases in such negative communications compared to previous instances (e.g., from the beginning of, or within, the query time span) of the same counts (e.g., count 324). Such previous instances may be stored in the database 115, accessed by the threshold checker 230, and compared by the threshold checker 230 against their corresponding current instances obtained in operation 520 to detect which of the counts 320, 322, and 324 of negative communications have increased. In example embodiments that include operation 840, the modifying of the time interval 402 in operation 570 has the effect of reducing the time interval 402 in response to an increase in at least one of the counts 320, 322, and 324 of negative communications.

Such a reduction in the time interval 402 accordingly may cause periodic messages that reference the purchasable product to be communicated to the device 130 of the user 132 with an increased frequency of communication. For example, this increase in the frequency of communication may be useful when there is an increasing trend in negative communications being processed by one or more of the social media servers 120, 122, and 124, since a rising trend in negative communications may signify increased public attention on the purchasable product, decreasing prices for the purchasable product, increasing availability of the purchasable product, or any suitable combination thereof. This increase in the frequency of communications is represented in FIG. 8 by operation 870, which may be performed as part of operation 570, in which the interval modifier 210 modifies the time interval 402.

In some example embodiments, the interval modifier 210 is further configured to detect decreases in one or more prices of the purchasable product. This is represented in FIG. 8 by operation 862. Operation 862 may be performed prior to operation 570, in which the interval modifier 210 modifies the time interval 402. In operation 862, the interval modifier 210 detects a decrease in a price (e.g., product price) at which the purchasable product is being sold. This may be performed by accessing the price from the database 115 (e.g., where a price gathering operation has been performed by the notification machine 110 or the database 115), by accessing the price from one or more third-party websites (e.g., shopping websites), or any suitable combination thereof, and then comparing the accessed price with a previous instance (e.g., stored in the database 115) of the price (e.g., from the beginning of, or within, the query time span) to detect whether the price of the purchasable product has decreased (e.g., detect that the price did decrease during the query time span). In example embodiments that include operation 862, the modifying (e.g., reducing) of the time interval 402 in operation 570 is further based on the detected decrease in the price of the purchasable product.

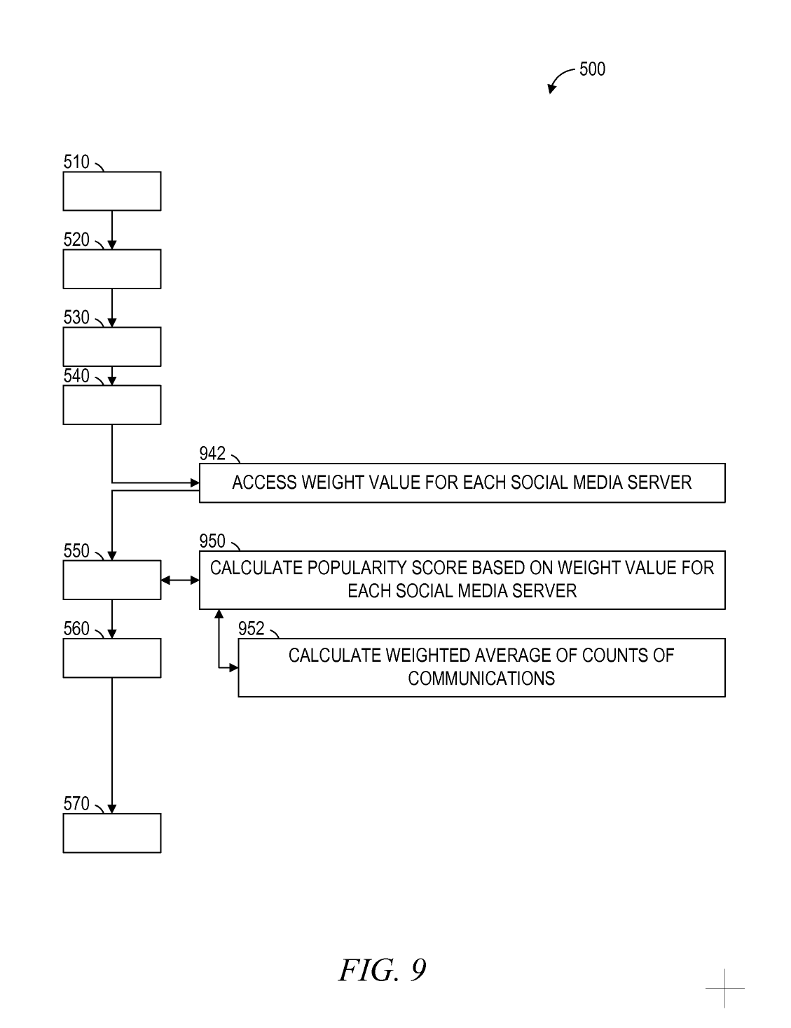

As shown in FIG. 9, the method 500 may include one or more of operations 942, 950, and 952. Operation 942 may be performed prior to operation 550, in which the popularity score 360 is calculated. In operation 942, the score generator 240 accesses the weight values 340, 342, and 344 from the database 115. For example, this may be performed by directly reading the weight values 340, 342, and 344 or by requesting and receiving the weight values 340, 342, and 344 from the database 115. In some example embodiments, the score generator 240 accesses the stored sets of weight values 412, 422, and 432 to obtain the weight values 340, 342, and 344. As noted above, each of the weight values 340, 342, and 344 corresponds to a different social media server (e.g., social media server 120, 122, or 124) and its corresponding API (e.g., including its corresponding API calls). In some example embodiments, a separate accessing operation may be performed for each individual weight value (e.g., weight value 340, 342, or 344).

Operation 950 may be performed as part of operation 550, in which the popularity score 360 is calculated. In operation 950, the score generator 240 calculates the popularity score 360 of the purchasable product based on the weight values 340, 342, and 344 accessed in operation 942. For example, the popularity score 360 may include calculation of a weighted average of one or more of the counts 320, 322, and 324 of communications obtained in operation 520. This is represented in FIG. 9 by operation 952.

In operation 952, the score generator 240 uses each of the different weight values 340, 342, and 344 in performing the calculation of such a weighted average. As one example, the score generator 240 may multiply each of the counts (e.g., counts 320 and 322) that transgressed its corresponding threshold value (e.g., threshold values 330 and 332) by its corresponding weight value (e.g., weight values 340 and 342) to obtain a corresponding weighted count (e.g., weighted counts 350 and 352). Thus, each of the counts (e.g., count 320) to be used in calculating the popularity score 360 may be weighted by a different weight value (e.g., weight value 340) that corresponds to a particular social media server (e.g., social media server 120). These weighted counts (e.g., weighted counts 350 and 352) may be averaged by the score generator 240 to obtain the weighted average in operation 952.

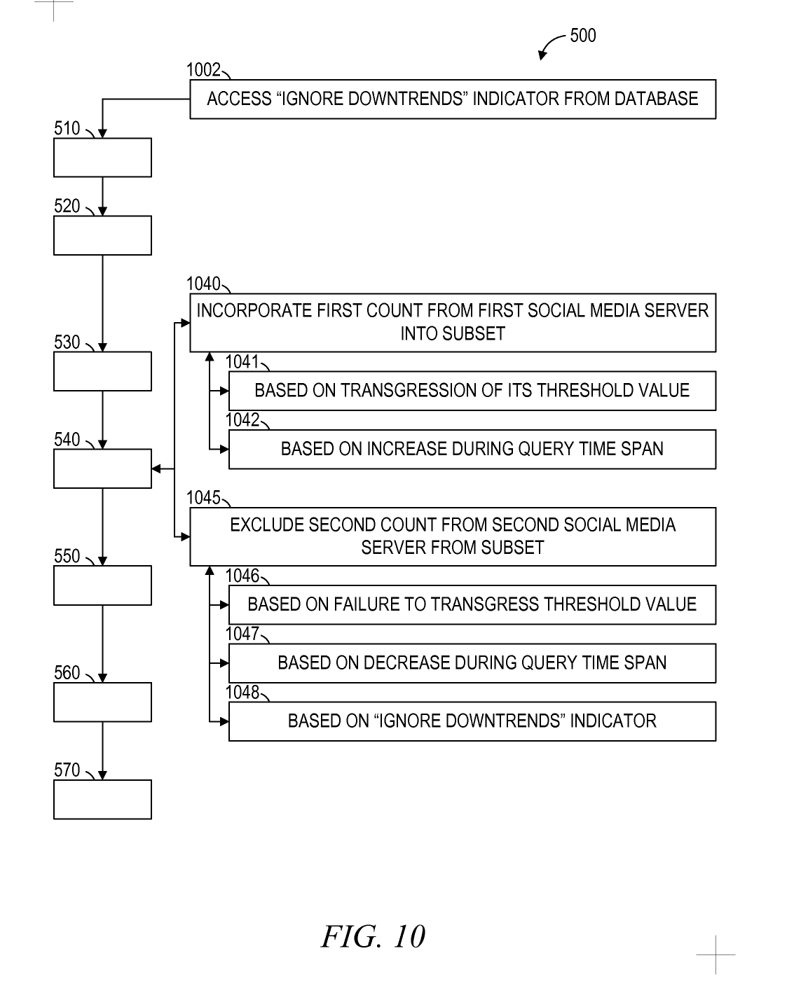

As shown in FIG. 10, the method 500 may include one or more of operations 1002, 1040, 1041, 1042, 1045, 1046, 1047, and 1048. Operation 1002 may be performed at any point prior to operation 540, in which the threshold checker 230 determines the subset of the counts (e.g., counts 320, 322, and 324) of communications. In operation 1002, the threshold checker 230 accesses the indicator 406 (e.g., an “ignore downtrends” flag) from the database 115. The accessing of the indicator 406 may be performed by directly reading the indicator 406 or requesting and obtaining the indicator 406 from the database 115.

One or both of operations 1040 and 1045 may be performed as part of operation 540, in which the subset is determined. In operation 1040, as part of determining the subset, the threshold checker 230 incorporates a count (e.g., a first count, such as the count 320, obtained from a first social media server, such as the social media server 120) into the subset. As shown in FIG. 10 by operation 1041, this incorporation may be based on the count transgressing its threshold value (e.g., based on the count 320 transgressing its threshold value 330). As illustrated by operation 1042, this incorporation may be based on the count (e.g., count 320) having been increased during the query time span (e.g., as detected in operation 740, operation 840, or both).

In operation 1045, as part of determining the subset, the threshold checker 230 excludes a count (e.g., a second count, such as count 324, obtained from a second social media server, such as social media server 124) from the subset. As shown in FIG. 10 by operation 1046, this exclusion may be based on the count failing to transgress its threshold value (e.g., based on the count 324 failing to transgress its threshold value 334). As depicted by operation 1047, this exclusion may be based on the count (e.g., count 324) having been decreased during the query time span (e.g., as detected during performance of operation 740, operation 840, or both). Furthermore, as depicted by operation 1048, this exclusion may be based on (e.g., responsive to) the indicator 406 accessed in operation 1002. That is, in example embodiments that include operation 1048, the presence or absence of the indicator 406 controls whether operation 1047 is performed.

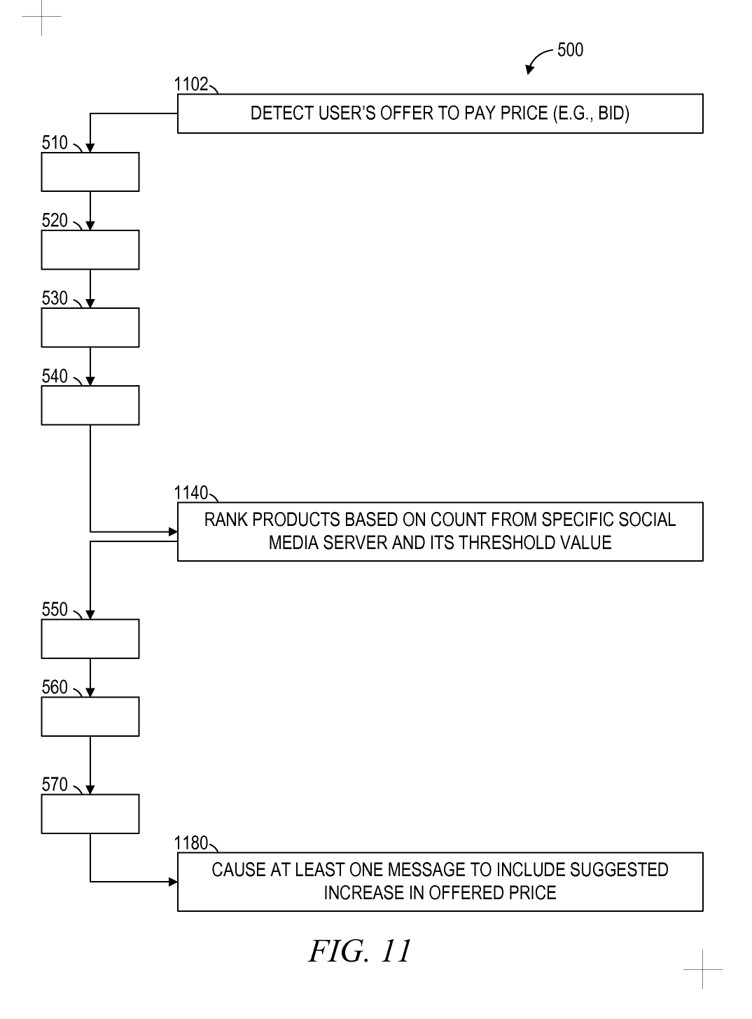

As shown in FIG. 11, the method 500 may include one or more of operations 1102, 1140, and 1180. Operation 1102 may be performed at any point prior to operation 570, in which the time interval 402 is modified. In operation 1102, the interval modifier 210 detects that the user 132 offered to pay a specified price (e.g., a bid price) for a specimen of the purchasable product. This may be performed by accessing the offered price from the database 115, accessing a third-party website (e.g., a shopping website or an auction website), or both.

In example embodiments that include operation 1102, operation 1180 may be performed after operation 570, in which the time interval 402 is modified. In operation 1180, the interval modifier 210 causes at least one future message (e.g., among multiple repeating messages) that references the purchasable product to be sent to the user 132, according to the modified time interval and including a suggested increase in the specified price (e.g., the offered price). This may have the effect of adding the suggested increase in the offered price to such future messages, as the future messages are sent according to the modified time interval 402 (e.g., with a correspondingly modified frequency of communication).

Operation 1140 may be performed at any point after operation 540, in which the threshold checker 230 determines the subset of the counts 320, 322, and 324 of communications. In operation 1140, the threshold checker 230 ranks a set of purchasable products. For example, the threshold checker 230 may rank a group (e.g., category or cluster) of multiple purchasable products, where the group includes the purchasable product of interest to the user 132 (e.g., as indicated in operation 602). The ranking of this set of purchasable products may be specific to a particular social media server (e.g., social media server 120). Accordingly, in ranking the set of purchasable products, the threshold checker 230 may rank the purchasable product of interest to the user 132 based on its corresponding count (e.g., count 320) obtained from that particular social media server (e.g., social media server 120).

As one example, the threshold checker 230 ranks each purchasable product in the set according to its corresponding count obtained from that particular social media server (e.g., social media server 120). As another example, the threshold checker 230 ranks the purchasable product by comparing its count (e.g., count 320) to the corresponding threshold value (e.g., threshold value 330) specific to that particular social media server (e.g., social media server 120) and then ranks each purchasable product in the set according to the difference between its count (e.g., count 320) and the corresponding threshold value (e.g., threshold value 330) for that social media server (e.g., social media server 120).

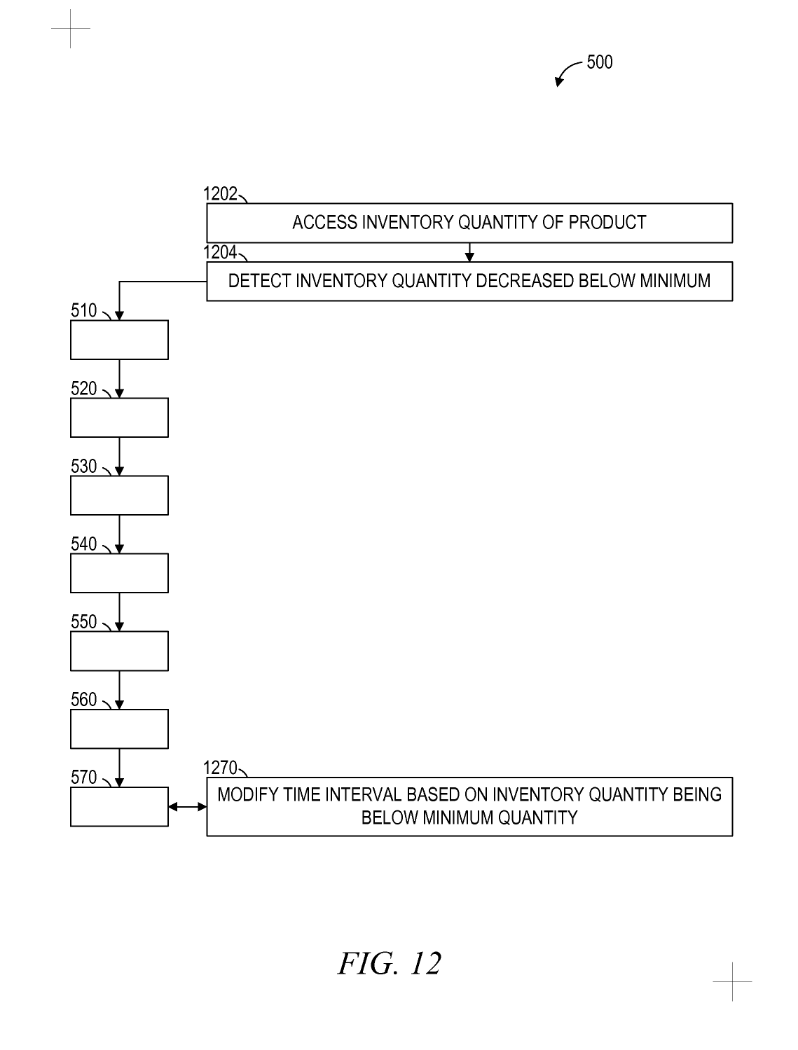

As shown in FIG. 12, some example embodiments of the method 500 can modify the time interval 402 in situations where the user 132 is interested in buying a specimen of the purchasable product, but one or more tracked inventories of such specimens are running low. Hence, the method 500 may include one or more of operations 1202, 1204, and 1270. Operations 1202 and 1204 may be performed at any point prior to operation 570, in which the time interval 402 is modified.

In operation 1202, the interval modifier 210 accesses an inventory quantity of the purchasable product. The inventory quantity is a numerical quantity (e.g., numerical value) that quantifies a number of specimens of the product within an inventory (e.g., at a shopping website or an auction website). The inventory quantity may be accessed (e.g., read, requested, received, or otherwise obtained) from the database 115, a website (e.g., a third-party website), or any suitable combination thereof.

In operation 1204, the interval modifier 210 detects that the inventory quantity has decreased below a threshold quantity (e.g., a minimum quantity). The threshold quantity may be generally applicable to all purchasable products. Alternatively, the threshold quantity may be specific to the purchasable product, specific to the user 132, or both. The threshold quantity may be stored in the database 115 and accessed from the database 115, stored by a website and accessed from the website, or any suitable combination thereof. The detection may be performed by comparing the inventory quantity to the threshold quantity (e.g., comparing their respective numerical values).

In example embodiments that include operation 1204, the interval modifier 210 may perform operation 570 based on the detection performed in operation 1204. As shown in FIG. 12, operation 1270 may be performed as part of operation 570. In operation 1270, the interval modifier 210 modifies the time interval 402 based on the inventory quantity of the purchasable product being below the threshold quantity. This may have the effect of increasing the frequency of communications (e.g., messages that reference the purchasable product) in situations where the user 132 is interested in purchasing an item (e.g., a specimen of the purchasable product), but one or more tracked inventories of such items is running low.

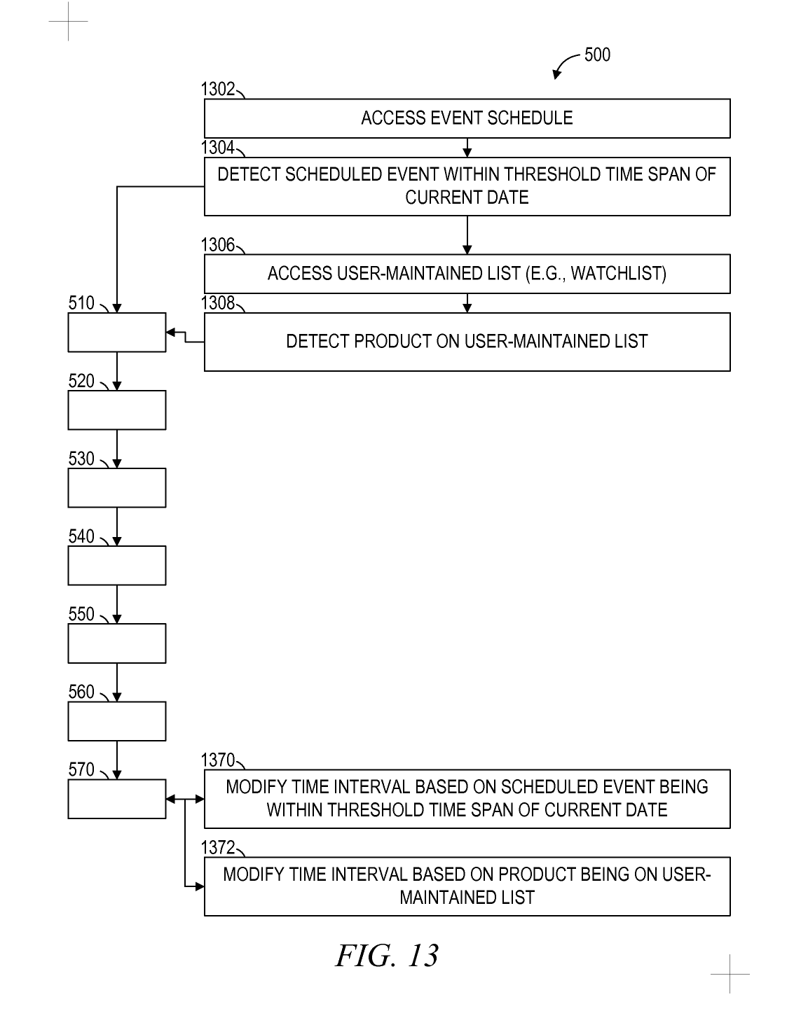

As shown in FIG. 13, some example embodiments of the method 500 can modify the time interval 402 in situations where popularity of the purchasable product increases as an upcoming event draws near. Furthermore, certain example embodiments modify the time interval 402 based on the user 132 having listed the purchasable product on a list (e.g., a watchlist, a wish list, a shopping list, a wedding registry, a birthday registry, or other user-maintained list of items). Hence, the method 500 may include one or more of operations 1302, 1304, 1306, 1308, 1370, and 1372. One or more of operations 1302, 1304, 1306, and 1308 may be performed at any point prior to operation 570, in which the time interval 402 is modified.

In operation 1302, the interval modifier 210 accesses an event schedule that lists one or more upcoming events (e.g., sports events, concerts, theater shows, movie releases, or lectures). In some situations, the event schedule is specific to the user 132 (e.g., a cloud-based personal calendar), specific to the device 130 of the user 132 (e.g., a device-stored calendar), or nonspecific to the user 132 (e.g., a public calendar, a venue calendar, a government calendar, or any suitable combination thereof). Accordingly, events listed in the event schedule may be personal, public, or any suitable combination thereof. The event schedule may be accessed from the database 115, a website (e.g., a third-party website), a calendar server (e.g., a third-party calendar server), or any suitable combination thereof. Within the event schedule, a scheduled event (e.g., a music concert) is slated to occur at some future time (e.g., a future date of the scheduled event) compared to a current date (e.g., when operation 1302 is performed). In addition, the database 115 stores a correlation (e.g., link, pointer, mapping, or assignment) between the scheduled event and the purchasable product.

In operation 1304, the interval modifier 210 detects that the scheduled event will occur within a threshold time span (e.g., one week, ten days, two weeks, or one month) of the current date on which operation 1304 is performed. For example, this detection may be performed by comparing the threshold time span to the difference between the current date and the date of the scheduled event. Based on this detection, the interval modifier 210 may access the correlation between the purchasable product and the scheduled event (e.g., as stored in the database 115).

Results of operation 1304 may be used in operation 1370, which may be performed as part of operation 570. As noted above, in operation 570, the interval modifier 210 modifies the time interval 402. According to operation 1370, the modification of the time interval 402 is based on the scheduled event being scheduled to occur within a threshold time span of the current date, as detected in operation 1304. This may have the effect of increasing the frequency of communications (e.g., messages that reference the purchasable product) in situations where the user 132 is interested in obtaining a specimen of the purchasable product in anticipation of, in preparation for, or otherwise prior to, the scheduled event that is correlated with the purchasable product.

In operation 1306, the interval modifier 210 accesses a user-maintained list that corresponds to the user 132 (e.g., a watchlist maintained by the user 132). The user-maintained list may be accessed from the database 115, a website (e.g., a third-party website), or any suitable combination thereof. Within the user-maintained list, an identifier (e.g., name or code) of the purchasable product indicates that the purchasable product is referenced by the user-maintained list.

In operation 1308, the interval modifier 210 detects that the purchasable product is referenced by the user-maintained list. For example, this detection may be performed by checking the user-maintained list for presence or absence of the identifier of the purchasable product.

Results of operation 1308 may be used in operations 1372, which may be performed as part of operation 570. As previously noted, the interval modifier 210 modifies the time interval 402 in operation 570. According to operation 1372, the modification of the time interval 402 is based on the identifier of the purchasable product being included in (e.g., appearing in) the user-maintained list that corresponds to the user 132, as detected in operation 1308. That is, the time interval 402 may be based on the purchasable product being represented (e.g., by its identifier) on or within the user-maintained list. This may have the effect of increasing the frequency of communications (e.g., messages that refer to the purchasable product) in situations where the user 132 has, by listing the purchasable product in his or her user-maintained list (e.g., watchlist), expressed interest in obtaining a specimen of the purchasable product.

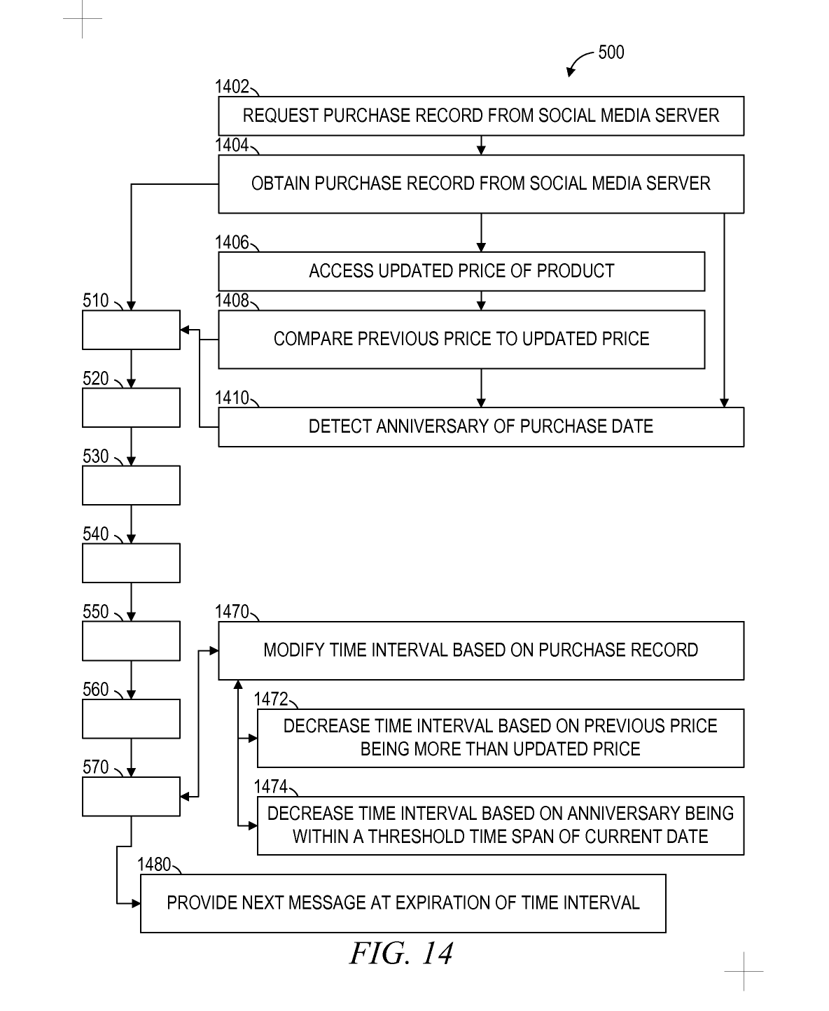

As shown in FIG. 14, some example embodiments of the method 500 can modify the time interval 402 in situations where at least one of the social media servers 120, 122, or 124 permits access (e.g., via one or more API calls) to purchase records of the user 132. In such situations, the notification machine 110 can modify the time interval 402 based on detection of an upcoming anniversary (e.g., yearly anniversary) of a previous purchase made by the user 132. Hence, the method 500 may include one or more of operations 1402, 1404, 1406, 1408, 1410, 1470, 1472, 1474, and 1480.

In operation 1402, the API caller 220 requests one or more purchase records of the user 132 from one or more of the social media servers 120, 122, and 124. For example, the API caller 220 may make an API call to the social media server 120, where the API call requests provision of copies of any purchase records for purchases made by the user 132 (e.g., within the query time span, within the past year, or between ten and twelve months ago). The API caller 220 may make such an API call to the social media server 120 (e.g., a first social media server) based on data (e.g., a list or other indication stored by the database 115) that indicates that the social media server 120 permits access to such purchase records (e.g., purchase records of all users of the social media server 120 or purchase records of the user 132 specifically).

In operation 1404, the API caller 220 obtains the purchase records requested in operation 1402. For example, the requested purchase records may be provided by the social media server 120 as an output of, or otherwise in response to, an API call made by the API caller 220 to the social media server 120. In some example embodiments, the obtained purchase records are stored in the database 115 for future use. One or more of the obtained purchase records may include a particular purchase record (e.g., first purchase record) that indicates that the user 132 previously bought a specimen of the purchasable product on a purchase date.

According to certain example embodiments, the particular purchase record (e.g., first purchase record) indicates a price (e.g., first price) previously paid by the user 132 for a specimen (e.g., first specimen) of the purchasable product. In such example embodiments, the interval modifier 210 may perform operation 1406, in which the interval modifier 210 accesses an updated price (e.g., second price) at which another specimen (e.g., second specimen) of the purchasable product is currently available for sale. For example, the updated price may be accessed from the database 115, from a website (e.g., a third-party website), or any suitable combination thereof. In operation 1408, the interval modifier 210 compares the previously paid price (e.g., first price) to the updated price (e.g., second price). This may be performed by comparing their numerical values. Based on this comparison, the interval modifier 210 may determine that the updated price has increased or decreased compared to the previously paid price.

According to various example embodiments, the purchase date on which the user 132 previously bought a specimen (e.g., first specimen) of the purchasable product may be used to influence the modification of the time interval 402 in operation 570. In such example embodiments, the interval modifier 210 performs operation 1410 by detecting that an anniversary (e.g., annual anniversary, biannual anniversary, triannual anniversary, or quarterly anniversary) of the purchase date will occur within a threshold time span (e.g., one week, ten days, two weeks, or one month) of the current date on which operation 1410 is performed. For example, this detection may be performed by comparing the threshold time span to the next occurrence of the anniversary (e.g., to the difference between the current date and the date of the next occurrence of the anniversary).

Results from operation 1404, operation 1408, operation 1410, or any suitable combination thereof may be used in operation 1470, which may be performed as part of operation 570. As noted above, in operation 570, the interval modifier 210 modifies the time interval 402. According to operation 1470, the modification of the time interval 402 is based on the particular purchase record (e.g., first purchase record) or a portion thereof. As shown in FIG. 14, one or both of operations 1472 and 1474 may be performed as part of operation 1470.

In operation 1472, the interval modifier 210 modifies the time interval 402 by decreasing the time interval 402 based on (e.g., in response to) the previously paid price (e.g., first price) of the purchasable product being greater than the updated price (e.g., second price) of the purchasable product. In some example embodiments, the time interval 402 is decreased based on the previously paid price being greater than or equal to the updated price. This may have the effect of increasing the frequency of communications (e.g., messages that reference the purchasable product) in situations where prices for the purchasable product are decreasing (e.g., have decreased over time, such as, during the query time span). According to various example embodiments, the method 500 may include one or more additional operations in which the interval modifier 210 decreases the frequency of communications in situations where prices for the purchasable product are increasing (e.g., have increased over time, such as, during the query time span).

In operation 1474, the interval modifier 210 modifies the time interval 402 by decreasing the time interval 402 based on (e.g., in response to) the anniversary (e.g., annual anniversary) of the purchase date occurring within the threshold time span (e.g., one week, ten days, two weeks, or one month) of the current date (e.g., on which operation 1410 was performed). This may have the effect of increasing the frequency of communications (e.g., messages that reference the purchasable product) in situations where the user 132 regularly, routinely, or periodically purchases specimens of the purchasable product (e.g., yearly purchases of seasonal clothing, biannual purchases of bedsheets or bathroom towels, triannual purchases of computer systems, or quarterly purchases of toilet paper), and another such purchase is automatically anticipated by the notification machine 110. According to various example embodiments, the method 500 may include one or more additional operations in which the interval modifier 210 decreases the frequency of communications in situations where the next anniversary of the purchase date lies beyond the threshold time span.

In operation 1480, the notification machine 110 (e.g., one or more of the processors 299) uses the modified time interval 402 to provide the next message (e.g., consecutive message that references the purchasable product) to the user 132. This message may be sent at the expiration of the modified time interval 402 (e.g., since the most recent previous message that referenced the purchasable product). In one example, the notification machine 110 generates the next message and waits until the modified time interval 402 has expired before sending the message. In another example, the notification machine 110 generates and sends the next message on the day or hour that the modified time interval 402 expires. In a further example, the notification machine 110 detects that the modified time interval 402 has already expired, and the notification machine 110 automatically generates and sends the next message immediately. According to certain example embodiments, the message is sent to the user 132 via the device 130.

In some implementations, performance of operation 680 is a basis (e.g., trigger) for performing operation 1480. That is, performance of operation 1480 may be based on (e.g., responsive to) performance of operation 680. As noted above, the purchasable product may be listed in a watchlist of the user 132 by virtue of an identifier (e.g., name or code) of the purchasable product appearing in the watchlist. Accordingly, the next message may reference the purchasable product by including the identifier of the purchasable product.

According to various example embodiments, one or more of the methodologies described herein may facilitate dynamic increases and decreases of a time interval (e.g., time interval 402) to be inserted between messages to be sent to a user (e.g., user 132). Moreover, one or more of the methodologies described herein may facilitate dynamic increases and decreases in the frequency of communicating messages that reference a purchasable product (e.g., bid update notifications). Hence, one or more of the methodologies described herein may facilitate improved provision of automatic communications requested, commanded, configured, or otherwise arranged by users (e.g., user 132), as well as improved convenience and usefulness to such users in their interactions with machines (e.g., in the network-based system 105).

When these effects are considered in aggregate, one or more of the methodologies described herein may obviate a need for certain efforts or resources that otherwise would be involved in implementing a notification machine (e.g., notification machine 110) that supports dynamic messaging intervals (e.g., time interval 402). Efforts expended by a user (e.g., user 132) in repeatedly configuring and reconfiguring his or her settings for automatic communications may be reduced by use of (e.g., reliance upon) a special-purpose machine that implements one or more of the methodologies described herein. Computing resources used by one or more systems or machines (e.g., within the network environment 100) may similarly be reduced (e.g., compared to systems or machines that lack the structures discussed herein or are otherwise unable to perform the functions discussed herein). Examples of such computing resources include processor cycles, network traffic, computational capacity, main memory usage, graphics rendering capacity, graphics memory usage, data storage capacity, power consumption, and cooling capacity.

FIG. 15 is a block diagram illustrating components of a machine 1500, according to some example embodiments, able to read instructions 1524 from a machine-readable medium 1522 (e.g., a non-transitory machine-readable medium, a machine-readable storage medium, a computer-readable storage medium, or any suitable combination thereof) and perform any one or more of the methodologies discussed herein, in whole or in part. Specifically, FIG. 15 shows the machine 1500 in the example form of a computer system (e.g., a computer) within which the instructions 1524 (e.g., software, a program, an application, an applet, an app, or other executable code) for causing the machine 1500 to perform any one or more of the methodologies discussed herein may be executed, in whole or in part.

In alternative embodiments, the machine 1500 operates as a standalone device or may be communicatively coupled (e.g., networked) to other machines. In a networked deployment, the machine 1500 may operate in the capacity of a server machine or a client machine in a server-client network environment, or as a peer machine in a distributed (e.g., peer-to-peer) network environment. The machine 1500 may be a server computer, a client computer, a personal computer (PC), a tablet computer, a laptop computer, a netbook, a cellular telephone, a smart phone, a set-top box (STB), a personal digital assistant (PDA), a web appliance, a network router, a network switch, a network bridge, or any machine capable of executing the instructions 1524, sequentially or otherwise, that specify actions to be taken by that machine. Further, while only a single machine is illustrated, the term “machine” shall also be taken to include any collection of machines that individually or jointly execute the instructions 1524 to perform all or part of any one or more of the methodologies discussed herein.

The machine 1500 includes a processor 1502 (e.g., one or more central processing units (CPUs), one or more graphics processing units (GPUs), one or more digital signal processors (DSPs), one or more application specific integrated circuits (ASICs), one or more radio-frequency integrated circuits (RFICs), or any suitable combination thereof), a main memory 1504, and a static memory 1506, which are configured to communicate with each other via a bus 1508. The processor 1502 contains solid-state digital microcircuits (e.g., electronic, optical, or both) that are configurable, temporarily or permanently, by some or all of the instructions 1524 such that the processor 1502 is configurable to perform any one or more of the methodologies described herein, in whole or in part. For example, a set of one or more microcircuits of the processor 1502 may be configurable to execute one or more modules (e.g., software modules) described herein. In some example embodiments, the processor 1502 is a multicore CPU (e.g., a dual-core CPU, a quad-core CPU, or a 128-core CPU) within which each of multiple cores behaves as a separate processor that is able to perform any one or more of the methodologies discussed herein, in whole or in part. Although the beneficial effects described herein may be provided by the machine 1500 with at least the processor 1502, these same beneficial effects may be provided by a different kind of machine that contains no processors (e.g., a purely mechanical system, a purely hydraulic system, or a hybrid mechanical-hydraulic system), if such a processor-less machine is configured to perform one or more of the methodologies described herein.

The machine 1500 may further include a graphics display 1510 (e.g., a plasma display panel (PDP), a light emitting diode (LED) display, a liquid crystal display (LCD), a projector, a cathode ray tube (CRT), or any other display capable of displaying graphics or video). The machine 1500 may also include an alphanumeric input device 1512 (e.g., a keyboard or keypad), a cursor input device 1514 (e.g., a mouse, a touchpad, a trackball, a joystick, a motion sensor, an eye tracking device, or other pointing instrument), a data storage 1516, an audio generation device 1518 (e.g., a sound card, an amplifier, a speaker, a headphone jack, or any suitable combination thereof), and a network interface device 1520.

The data storage 1516 (e.g., a data storage device) includes the machine-readable medium 1522 (e.g., a tangible and non-transitory machine-readable storage medium) on which are stored the instructions 1524 embodying any one or more of the methodologies or functions described herein. The instructions 1524 may also reside, completely or at least partially, within the main memory 1504, within the static memory 1506, within the processor 1502 (e.g., within the processor's cache memory), or any suitable combination thereof, before or during execution thereof by the machine 1500. Accordingly, the main memory 1504, the static memory 1506, and the processor 1502 may be considered machine-readable media (e.g., tangible and non-transitory machine-readable media). The instructions 1524 may be transmitted or received over the network 190 via the network interface device 1520. For example, the network interface device 1520 may communicate the instructions 1524 using any one or more transfer protocols (e.g., hypertext transfer protocol (HTTP)).

In some example embodiments, the machine 1500 may be a portable computing device (e.g., a smart phone, a tablet computer, or a wearable device), and may have one or more additional input components 1530 (e.g., sensors or gauges). Examples of such input components 1530 include an image input component (e.g., one or more cameras), an audio input component (e.g., one or more microphones), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), a biometric input component (e.g., a heartrate detector or a blood pressure detector), and a gas detection component (e.g., a gas sensor). Input data gathered by any one or more of these input components may be accessible and available for use by any of the modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1522 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing the instructions 1524 for execution by the machine 1500, such that the instructions 1524, when executed by one or more processors of the machine 1500 (e.g., processor 1502), cause the machine 1500 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible and non-transitory data repositories (e.g., data volumes) in the example form of a solid-state memory chip, an optical disc, a magnetic disc, or any suitable combination thereof. A “non-transitory” machine-readable medium, as used herein, specifically does not include propagating signals per se. In some example embodiments, the instructions 1524 for execution by the machine 1500 may be communicated by a carrier medium. Examples of such a carrier medium include a storage medium (e.g., a non-transitory machine-readable storage medium, such as a solid-state memory, being physically moved from one place to another place) and a transient medium (e.g., a propagating signal that communicates the instructions 1524).

Certain example embodiments are described herein as including modules. Modules may constitute software modules (e.g., code stored or otherwise embodied in a machine-readable medium or in a transmission medium), hardware modules, or any suitable combination thereof. A “hardware module” is a tangible (e.g., non-transitory) physical component (e.g., a set of one or more processors) capable of performing certain operations and may be configured or arranged in a certain physical manner. In various example embodiments, one or more computer systems or one or more hardware modules thereof may be configured by software (e.g., an application or portion thereof) as a hardware module that operates to perform operations described herein for that module.

In some example embodiments, a hardware module may be implemented mechanically, electronically, hydraulically, or any suitable combination thereof. For example, a hardware module may include dedicated circuitry or logic that is permanently configured to perform certain operations. A hardware module may be or include a special-purpose processor, such as a field programmable gate array (FPGA) or an ASIC. A hardware module may also include programmable logic or circuitry that is temporarily configured by software to perform certain operations. As an example, a hardware module may include software encompassed within a CPU or other programmable processor. It will be appreciated that the decision to implement a hardware module mechanically, hydraulically, in dedicated and permanently configured circuitry, or in temporarily configured circuitry (e.g., configured by software) may be driven by cost and time considerations.

Accordingly, the phrase “hardware module” should be understood to encompass a tangible entity that may be physically constructed, permanently configured (e.g., hardwired), or temporarily configured (e.g., programmed) to operate in a certain manner or to perform certain operations described herein. Furthermore, as used herein, the phrase “hardware-implemented module” refers to a hardware module. Considering example embodiments in which hardware modules are temporarily configured (e.g., programmed), each of the hardware modules need not be configured or instantiated at any one instance in time. For example, where a hardware module includes a CPU configured by software to become a special-purpose processor, the CPU may be configured as respectively different special-purpose processors (e.g., each included in a different hardware module) at different times. Software (e.g., a software module) may accordingly configure one or more processors, for example, to become or otherwise constitute a particular hardware module at one instance of time and to become or otherwise constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory (e.g., a memory device) to which it is communicatively coupled. A further hardware module may then, at a later time, access the memory to retrieve and process the stored output. Hardware modules may also initiate communications with input or output devices, and can operate on a resource (e.g., a collection of information from a computing resource).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module in which the hardware includes one or more processors. Accordingly, the operations described herein may be at least partially processor-implemented, hardware-implemented, or both, since a processor is an example of hardware, and at least some operations within any one or more of the methods discussed herein may be performed by one or more processor-implemented modules, hardware-implemented modules, or any suitable combination thereof.

Moreover, such one or more processors may perform operations in a “cloud computing” environment or as a service (e.g., within a “software as a service” (SaaS) implementation). For example, at least some operations within any one or more of the methods discussed herein may be performed by a group of computers (e.g., as examples of machines that include processors), with these operations being accessible via a network (e.g., the Internet) and via one or more appropriate interfaces (e.g., an API). The performance of certain operations may be distributed among the one or more processors, whether residing only within a single machine or deployed across a number of machines. In some example embodiments, the one or more processors or hardware modules (e.g., processor-implemented modules) may be located in a single geographic location (e.g., within a home environment, an office environment, or a server farm). In other example embodiments, the one or more processors or hardware modules may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and their functionality presented as separate components and functions in example configurations may be implemented as a combined structure or component with combined functions. Similarly, structures and functionality presented as a single component may be implemented as separate components and functions. These and other variations, modifications, additions, and improvements fall within the scope of the subject matter herein.

Some portions of the subject matter discussed herein may be presented in terms of algorithms or symbolic representations of operations on data stored as bits or binary digital signals within a memory (e.g., a computer memory or other machine memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “accessing,” “processing,” “detecting,” “computing,” “calculating,” “determining,” “generating,” “presenting,” “displaying,” or the like refer to actions or processes performable by a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

The following enumerated embodiments describe various example embodiments of methods, machine-readable media, and systems (e.g., machines, devices, or other apparatus) discussed herein.

A first embodiment provides a method comprising:

by one or more processors of a machine, accessing stored data that specifies a time interval to be inserted between consecutive messages to be sent to a user, the consecutive messages to reference a purchasable product;
by one or more processors of the machine, accessing social media servers that each provide a different social media service and that each provide a different application programming interface (API), the accessing including requesting and obtaining counts of communications that each referenced the purchasable product during a query time span, each of the counts of communications being obtained from a different social media server among the social media servers via its corresponding API;
by one or more processors of the machine, accessing threshold values from a database, each threshold value among the threshold values corresponding to a different social media server among the social media servers and its corresponding API;
by one or more processors of the machine, determining a subset of the counts of communications, each count in the subset transgressing a corresponding threshold value among the threshold values, the determining of the subset including comparing each of the counts to its corresponding threshold value;
by one or more processors of the machine, calculating a popularity score of the purchasable product based on the subset of the counts of communications and comparing the calculated popularity score to a threshold popularity score (e.g., accessed from the database); and
by one or more processors of the machine, modifying the time interval to be inserted between the consecutive messages based on the calculated popularity score transgressing the threshold popularity score.

A second embodiment provides a method according to the first embodiment, wherein:

the modifying of the time interval causes periodic messages that reference the purchasable product to be communicated to a device of the user with a modified frequency of communication.

A third embodiment provides a method according to the first embodiment or the second embodiment, wherein:

the counts of communications are numerical quantities of positive communications that express positive sentiments about the purchasable product; and
the modifying of the time interval reduces the time interval in response to an increase in at least one of the numerical quantities of positive communications and causes periodic messages that reference the purchasable product to be communicated to a device of the user with an increased frequency of communication.

A fourth embodiment provides a method according to any of the first through third embodiments, wherein:

the counts of communications are numerical quantities of negative communications that express negative sentiments about the purchasable product; and the method further comprises:
detecting that a price of the purchasable product has decreased during the query time span; and wherein:
the modifying of the time interval reduces the time interval in response to an increase in at least one of the numerical quantities of negative communications and causes periodic messages that reference the purchasable product to be communicated to a device of the user with an increased frequency of communication.

A fifth embodiment provides a method according to any of the first through fourth embodiments, further comprising:

accessing weight values from the database, each weight value among the weight values corresponding to a different social media server among the social media servers and its corresponding API; and wherein:
the calculating of the popularity score of the purchasable product is further based on the weight values that each correspond to a different social media server among the social media servers and its API.

A sixth embodiment provides a method according to the fifth embodiment, wherein:

the calculating of the popularity score includes calculating a weighted average of the counts of communications obtained from the social media servers, each of the counts being weighted by a different weight value among the weight values that each correspond to a different social media server among the social media servers.

A seventh embodiment provides a method according to any of the first through sixth embodiments, wherein:

the determining of the subset of the counts of communications includes:
incorporating a first count among the counts into the subset based on the first count transgressing a corresponding first threshold value among the threshold values; and
excluding a second count among the counts from the subset based on the second count failing to transgress a corresponding second threshold value among the threshold values.

An eighth embodiment provides a method according to any of the first through seventh embodiments, wherein:

the determining of the subset of the counts of communications includes:
incorporating a first count among the counts into the subset based on the first count having increased during the query time span; and
excluding a second count among the counts from the subset based on the second count having decreased during the query time span.

A ninth embodiment provides a method according to the eighth embodiment, further comprising:

accessing an indicator from the database, the indicator indicating that decreased counts are to be ignored in the calculating of the popularity score; and wherein:
the excluding of the second count is responsive to the accessed indicator.

A tenth embodiment provides a method according to any of the first through ninth embodiments, further comprising:

detecting that the user has offered to pay a price to buy a specimen of the purchasable product; and
causing at least one of the consecutive messages to include a suggested increase in the offered price to buy the specimen of the purchasable product.

An eleventh embodiment provides a method according to any of the first through tenth embodiments, wherein:

a first count of communications among the counts of communications is obtained from a first social media server among the social media servers; and
a first threshold value among the threshold values corresponds to the first social media server and its API; and the method further comprises:
ranking a set of purchasable products that includes the purchasable product, the purchasable product being ranked based on a comparison of the first count to the first threshold value that corresponds to the first social media server and its API.

A twelfth embodiment provides a method according to any of the first through eleventh embodiments, further comprising:

accessing an inventory quantity of the purchasable product from the database; and
detecting that the inventory quantity of the purchasable product decreased below a minimum quantity of the purchasable product; and wherein:
the modifying of the time interval is further based on the inventory quantity of the purchasable product being below the minimum quantity of the purchasable product.

A thirteenth embodiment provides a method according to any of the first through twelfth embodiments, further comprising:

accessing an event schedule from the database, the database correlating a scheduled event represented in the event schedule with the purchasable product; and
detecting that the scheduled event will occur within a threshold time span of a current date; and wherein:
the modifying of the time interval is further based on the scheduled event occurring within the threshold time span of the current date.

A fourteenth embodiment provides a method according to the any of the first through thirteenth embodiments, further comprising:

accessing a user-maintained list of purchasable products from the database, the user-maintained list corresponding to the user; and
detecting that the purchasable product is represented on the user-maintained list; and wherein:
the modifying of the time interval is further based on the purchasable product being represented on the user-maintained list that corresponds to the user.

A fifteenth embodiment provides a method according to any of the first through fourteenth embodiments, further comprising:

requesting and obtaining a purchase record from a social media server among the social media servers via its corresponding API, the purchase record indicating that the user previously bought a specimen of the purchasable product; and wherein:
the modifying of the time interval is further based on the purchase record that indicates that the user previously bought the specimen of the purchasable product.

A sixteenth embodiment provides a method according to the fifteenth embodiment, wherein:

the purchase record obtained from the social media server indicates a first price previously paid by the user for a first specimen of the purchasable product; and the method further comprises:
accessing a second price at which a second specimen of the purchasable product is available for sale, the second price being accessed from the database; and
comparing the first price to the second price; and wherein
the modifying of the time interval includes decreasing the time interval in response to the first price being greater than the second price.

A seventeenth embodiment provides a method according to the fifteenth embodiment or the sixteenth embodiment, wherein:

the purchase record obtained from the social media server indicates a purchase date on which the user bought a first specimen of the purchasable product; and the method further comprises:
detecting that an anniversary of the purchase date will occur within a threshold time span of a current date; and wherein
the modifying of the time interval includes decreasing the time interval in response to the anniversary occurring within the threshold time span of the current date.

An eighteenth embodiment provides a machine-readable medium (e.g., a non-transitory machine-readable storage medium) comprising instructions that, when executed by one or more processors (e.g., processors 299) of a machine (e.g., notification machine 110), cause the machine to perform operations comprising:

accessing stored data that specifies a time interval to be inserted between consecutive messages to be sent to a user, the consecutive messages to reference a purchasable product;
accessing social media servers that each provide a different social media service and that each provide a different application programming interface (API), the accessing including requesting and obtaining counts of communications that each referenced the purchasable product during a query time span, each of the counts of communications being obtained from a different social media server among the social media servers via its corresponding API;
accessing threshold values from a database, each threshold value among the threshold values corresponding to a different social media server among the social media servers and its corresponding API;
determining a subset of the counts of communications, each count in the subset transgressing a corresponding threshold value among the threshold values, the determining of the subset including comparing each of the counts to its corresponding threshold value;
calculating a popularity score of the purchasable product based on the subset of the counts of communications and comparing the calculated popularity score to a threshold popularity score (e.g., accessed from the database); and
modifying the time interval to be inserted between the consecutive messages based on the calculated popularity score transgressing the threshold popularity score.

A nineteenth embodiment provides a system (e.g., notification machine 110, cloud 118, or network-based system 105) comprising:

processors (e.g., processors 299); and
a memory (e.g., main memory 1504) storing instructions that, when executed by at least one processor among the processors, cause the system to perform operations comprising:
accessing stored data that specifies a time interval to be inserted between consecutive messages to be sent to a user, the consecutive messages to reference a purchasable product;
accessing social media servers that each provide a different social media service and that each provide a different application programming interface (API), the accessing including requesting and obtaining counts of communications that each referenced the purchasable product during a query time span, each of the counts of communications being obtained from a different social media server among the social media servers via its corresponding API;
accessing threshold values from a database, each threshold value among the threshold values corresponding to a different social media server among the social media servers and its corresponding API;
determining a subset of the counts of communications, each count in the subset transgressing a corresponding threshold value among the threshold values, the determining of the subset including comparing each of the counts to its corresponding threshold value;
calculating a popularity score of the purchasable product based on the subset of the counts of communications and comparing the calculated popularity score to a threshold popularity score (e.g., accessed from the database); and
modifying the time interval to be inserted between the consecutive messages based on the calculated popularity score transgressing the threshold popularity score.

A twentieth embodiment provides a system according to the nineteenth embodiment, wherein:

the modifying of the time interval causes periodic messages that reference the purchasable product to be communicated to a device of the user with a modified frequency of communication.

A twenty-first embodiment provides a carrier medium carrying machine-readable instructions for controlling a machine to carry out the method of any one of the previously described embodiments.

What is claimed is:

1. A method comprising:
by one or more processors of a machine, accessing stored data that specifies a time interval to be inserted between consecutive messages to be sent to a user, the consecutive messages to reference a purchasable product;
by one or more processors of the machine, accessing social media servers that each provide a different social media service and that each provide a different application programming interface (API), the accessing including requesting and obtaining counts of communications that each referenced the purchasable product during a query time span, each of the counts of communications being obtained from a different social media server among the social media servers via its corresponding API;
by one or more processors of the machine, accessing threshold values from a database, each threshold value among the threshold values corresponding to a different social media server among the social media servers and its corresponding API;
by one or more processors of the machine, determining a subset of the counts of communications, each count in the subset transgressing a corresponding threshold value among the threshold values, the determining of the subset including comparing each of the counts to its corresponding threshold value;
by one or more processors of the machine, calculating a popularity score of the purchasable product based on the subset of the counts of communications and comparing the calculated popularity score to a threshold popularity score; and
by one or more processors of the machine, modifying the time interval to be inserted between the consecutive messages based on the calculated popularity score transgressing the threshold popularity score.

2. The method of claim 1, wherein:
the modifying of the time interval causes periodic messages that reference the purchasable product to be communicated to a device of the user with a modified frequency of communication.

3. The method of claim 1, wherein:
the counts of communications are numerical quantities of positive communications that express positive sentiments about the purchasable product; and
the modifying of the time interval reduces the time interval in response to an increase in at least one of the numerical quantities of positive communications and causes periodic messages that reference the purchasable product to be communicated to a device of the user with an increased frequency of communication.

4. The method of claim 1, wherein:
the counts of communications are numerical quantities of negative communications that express negative sentiments about the purchasable product; and the method further comprises
detecting that a price of the purchasable product has decreased during the query time span; and wherein
the modifying of the time interval reduces the time interval in response to an increase in at least one of the numerical quantities of negative communications and causes periodic messages that reference the purchasable product to be communicated to a device of the user with an increased frequency of communication.

5. The method of claim 1, further comprising:
accessing weight values from the database, each weight value among the weight values corresponding to a different social media server among the social media servers and its corresponding API; and wherein
the calculating of the popularity score of the purchasable product is further based on the weight values that each correspond to a different social media server among the social media servers and its API.

6. The method of claim 5, wherein:
the calculating of the popularity score includes calculating a weighted average of the counts of communications obtained from the social media servers, each of the counts being weighted by a different weight value among the weight values that each correspond to a different social media server among the social media servers.

7. The method of claim 1, wherein:
the determining of the subset of the counts of communications includes:
incorporating a first count among the counts into the subset based on the first count transgressing a corresponding first threshold value among the threshold values; and
excluding a second count among the counts from the subset based on the second count failing to transgress a corresponding second threshold value among the threshold values.

8. The method of claim 1, wherein:
the determining of the subset of the counts of communications includes:
incorporating a first count among the counts into the subset based on the first count having increased during the query time span; and
excluding a second count among the counts from the subset based on the second count having decreased during the query time span.

9. The method of claim 8, further comprising:
accessing an indicator from the database, the indicator indicating that decreased counts are to be ignored in the calculating of the popularity score; and wherein
the excluding of the second count is responsive to the accessed indicator.

10. The method of claim 1, further comprising:
detecting that the user has offered to pay a price to buy a specimen of the purchasable product; and
causing at least one of the consecutive messages to include a suggested increase in the offered price to buy the specimen of the purchasable product.

11. The method of claim 1, wherein:
a first count of communications among the counts of communications is obtained from a first social media server among the social media servers;
a first threshold value among the threshold values corresponds to the first social media server and its API; and the method further comprises
ranking a set of purchasable products that includes the purchasable product, the purchasable product being ranked based on a comparison of the first count to the first threshold value that corresponds to the first social media server and its API.

12. The method of claim 1, further comprising:
accessing an inventory quantity of the purchasable product from the database; and
detecting that the inventory quantity of the purchasable product decreased below a minimum quantity of the purchasable product; and wherein
the modifying of the time interval is further based on the inventory quantity of the purchasable product being below the minimum quantity of the purchasable product.

13. The method of claim 1, further comprising:
accessing an event schedule from the database, the database correlating a scheduled event represented in the event schedule with the purchasable product; and
detecting that the scheduled event will occur within a threshold time span of a current date; and wherein
the modifying of the time interval is further based on the scheduled event occurring within the threshold time span of the current date.

14. The method of claim 1, further comprising:
accessing a user-maintained list of purchasable products from the database, the user-maintained list corresponding to the user; and
detecting that the purchasable product is represented on the user-maintained list; and wherein
the modifying of the time interval is further based on the purchasable product being represented on the user-maintained list that corresponds to the user.

15. The method of claim 1, further comprising:
requesting and obtaining a purchase record from a social media server among the social media servers via its corresponding API, the purchase record indicating that the user previously bought a specimen of the purchasable product; and wherein
the modifying of the time interval is further based on the purchase record that indicates that the user previously bought the specimen of the purchasable product.

16. The method of claim 15, wherein:
the purchase record obtained from the social media server indicates a first price previously paid by the user for a first specimen of the purchasable product; and the method further comprises:
accessing a second price at which a second specimen of the purchasable product is available for sale, the second price being accessed from the database; and
comparing the first price to the second price; and wherein
the modifying of the time interval includes decreasing the time interval in response to the first price being greater than the second price.

17. The method of claim 15, wherein:
the purchase record obtained from the social media server indicates a purchase date on which the user bought a first specimen of the purchasable product; and the method further comprises:
detecting that an anniversary of the purchase date will occur within a threshold time span of a current date; and wherein
the modifying of the time interval includes decreasing the time interval in response to the anniversary occurring within the threshold time span of the current date.

18. A non-transitory machine-readable storage medium comprising instructions that, when executed by one or more processors of a machine, cause the machine to perform operations comprising:
accessing stored data that specifies a time interval to be inserted between consecutive messages to be sent to a user, the consecutive messages to reference a purchasable product;
accessing social media servers that each provide a different social media service and that each provide a different application programming interface (API), the accessing including requesting and obtaining counts of communications that each referenced the purchasable product during a query time span, each of the counts of communications being obtained from a different social media server among the social media servers via its corresponding API;
accessing threshold values from a database, each threshold value among the threshold values corresponding to a different social media server among the social media servers and its corresponding API;
determining a subset of the counts of communications, each count in the subset transgressing a corresponding threshold value among the threshold values, the determining of the subset including comparing each of the counts to its corresponding threshold value;
calculating a popularity score of the purchasable product based on the subset of the counts of communications and comparing the calculated popularity score to a threshold popularity score; and
modifying the time interval to be inserted between the consecutive messages based on the calculated popularity score transgressing the threshold popularity score.

19. A system comprising:
processors; and
a memory storing instructions that, when executed by at least one processor among the processors, cause the system to perform operations comprising:
accessing stored data that specifies a time interval to be inserted between consecutive messages to be sent to a user, the consecutive messages to reference a purchasable product;
accessing social media servers that each provide a different social media service and that each provide a different application programming interface (API), the accessing including requesting and obtaining counts of communications that each referenced the purchasable product during a query time span, each of the counts of communications being obtained from a different social media server among the social media servers via its corresponding API;
accessing threshold values from a database, each threshold value among the threshold values corresponding to a different social media server among the social media servers and its corresponding API;
determining a subset of the counts of communications, each count in the subset transgressing a corresponding threshold value among the threshold values, the determining of the subset including comparing each of the counts to its corresponding threshold value;
calculating a popularity score of the purchasable product based on the subset of the counts of communications and comparing the calculated popularity score to a threshold popularity score; and
modifying the time interval to be inserted between the consecutive messages based on the calculated popularity score transgressing the threshold popularity score.

20. The system of claim 19, wherein:
the modifying of the time interval causes periodic messages that reference the purchasable product to be communicated to a device of the user with a modified frequency of communication.
